(19) United States
(12) Patent Application Publication
(10) Pub. No.: US 2022/0178498 A1
(43) Pub. Date: Jun. 9, 2022

(54) POWER SUPPLY

(71) Applicant: H2GO POWER LTD, London (GB)

(72) Inventors: Luke SPERRIN, London (GB); Enass ABO HAMED, London (GB); Peter ITALIANO, London (GB); Kieran O'DONNELL, London (GB)

(21) Appl. No.: 17/442,810

(22) PCT Filed: Mar. 27, 2020
(86) PCT No.: PCT/GB2020/050827

§ 371 Date: Sep. 24, 2021

(30) Foreign Application Priority Data
Mar. 27, 2019 (GB) 1904259.7
Mar. 26, 2020 (GB) 2004425.1

(51) Int. Cl. F17C 11/00; H01M 8/04082; H01M 8/04701; H05B 1/02

(52) U.S. Cl. CPC F17C 11/005; H01M 8/04201; H01M 8/04708; F17C 2270/0581; F17C 2221/012; F17C 2227/0302; H05B 1/0244

(57) ABSTRACT

A power supply 100 is described. The power supply 100 has a first electrical outlet 110 and comprises: optionally a set of hydrogen storage devices 200, including a first hydrogen storage device 200A, a set of heaters 300, including a first heater 300A, a first releasable fluid inlet coupling 410 and/or a first releasable fluid outlet coupling 510; wherein the first hydrogen storage device 200A comprises: a pressure vessel 230A, having a first fluid inlet 210A and a first fluid outlet 220A, comprising therein a thermally conducting network 240A optionally thermally coupled to the first heater 300A, wherein the pressure vessel 230A is arranged to receive therein a hydrogen storage material 250A in thermal contact, at least in part, with the thermally conducting network 240A, wherein the first fluid inlet 210A and/or the first fluid outlet 220A are in fluid communication with the first releasable fluid inlet coupling 410 and/or the first releasable fluid outlet coupling 510, respectively; and preferably, wherein the thermally conducting network 240A has lattice geometry and/or a fractal geometry in two and/or three dimensions.

### BACKGROUND

### Technical Field

The present invention relates generally to the field of power supplies. More particularly, the present invention relates to a power supply and a method of controlling a power supply.

### Related Art

Hydrogen is an environmentally-attractive alternative fuel to fossil fuels. Importantly, hydrogen can be produced without the use of fossil fuels, such as by the electrolysis of water using renewable energy. Hydrogen has a relatively high density of energy per unit mass and is effectively non-polluting since the main combustion product is water.

While hydrogen has wide potential application as a fuel, a major drawback in its utilization has been lack of suitable storage. Conventionally, hydrogen is stored in a pressure vessel as a compressed gas under a high pressure or stored as a cryogenic liquid, being cooled to an extremely low temperature. However, storage of hydrogen as a compressed gas generally involves use of large pressure vessels, limiting deployment at, for example, remote sites. Further, liquid hydrogen is expensive to produce while storage of hydrogen as a liquid presents a serious safety problem and requires storage below 20 K, thus precluding use in temporary installations, for example. Furthermore, scalability of storage, using conventional pressure vessels or liquid hydrogen, is limited by the associated infrastructure requirements, as mandated by safety and/or cost.

Hence, use of hydrogen as a fuel for electrical generation, for example at remote sites and/or temporary installations, is problematic.

### SUMMARY OF THE INVENTION

According to the present invention there is provided a power supply, a method of controlling a power supply and a computer-readable storage medium as set forth in the appended claims. Additional features of the invention will be apparent from the dependent claims, and the description herein.

A first aspect provides a power supply, having a first electrical outlet, comprising: a set of hydrogen storage devices, including a first hydrogen storage device, optionally a set of heaters including a first heater, a first releasable fluid inlet coupling and/or a first releasable fluid outlet coupling; wherein the first hydrogen storage device comprises: a pressure vessel, having a first fluid inlet and a first fluid outlet, comprising therein a thermally conducting network optionally thermally coupled to the first heater, wherein the pressure vessel is arranged to receive therein a hydrogen storage material in thermal contact, at least in part, with the thermally conducting network, wherein the first fluid inlet and/or the first fluid outlet are in fluid communication with the first releasable fluid inlet coupling and/or the first releasable fluid outlet coupling, respectively; and preferably, wherein the thermally conducting network has a lattice geometry, a gyroidal geometry and/or a fractal geometry in two and/or three dimensions.

A second aspect provides a method of controlling a power supply comprising a set of hydrogen gas generators, including a first hydrogen gas generator, a set of hydrogen storage devices, including a first hydrogen storage device, optionally a set of heaters including a first heater, a set of electrical generators, including a first electrical generator and a controller; wherein the first hydrogen storage device comprises: a pressure vessel, having a first fluid inlet and a first fluid outlet, comprising therein a thermally conducting network optionally thermally coupled to the first heater, wherein the pressure vessel is arranged to receive therein a hydrogen storage material in thermal contact, at least in part, with the thermally conducting network, and preferably, wherein the thermally conducting network has a lattice geometry, a gyroidal geometry and/or a fractal geometry in two and/or three dimensions; wherein the method comprises: generating, by the first hydrogen gas generator, hydrogen gas; storing, by the first hydrogen storage device, the generated hydrogen gas; releasing, at least in part, the stored hydrogen gas optionally comprising controlling, by the controller, the first heater to release, at least in part, the stored hydrogen gas; and generating, by the first electrical generator, electrical energy using the released hydrogen gas.

A third aspect provides a tangible non-transient computer-readable storage medium having recorded thereon instructions which when implemented by a computer device comprising a processor and a memory, cause the computer device to perform a method according to the second aspect.

### DETAILED DESCRIPTION OF THE INVENTION

### Power Supply

The first aspect provides a power supply, having a first electrical outlet, comprising: a set of hydrogen storage devices, including a first hydrogen storage device, optionally a set of heaters including a first heater, a first releasable fluid inlet coupling and/or a first releasable fluid outlet coupling; wherein the first hydrogen storage device comprises: a pressure vessel, having a first fluid inlet and a first fluid outlet, comprising therein a thermally conducting network optionally thermally coupled to the first heater, wherein the pressure vessel is arranged to receive therein a hydrogen storage material in thermal contact, at least in part, with the thermally conducting network, wherein the first fluid inlet and/or the first fluid outlet are in fluid communication with the first releasable fluid inlet coupling and/or the first releasable fluid outlet coupling, respectively; and preferably, wherein the thermally conducting network has a lattice geometry, a gyroidal geometry and/or a fractal geometry in two and/or three dimensions.

In this way, the power supply provides a modular and/or scalable source of electrical power, obtainable from hydrogen stored in the hydrogen storage material. Particularly, the hydrogen stored in the hydrogen storage material may be released, for example by heating thereof, via the thermally conducting network, by the first heater. Chemical energy of the released hydrogen may be then converted, at least in part, to electrical energy via an electrical generator. Furthermore, modularity and/or scalability of the power supply is provided by the first releasable fluid inlet coupling and/or the first releasable fluid outlet coupling. For example, by coupling and subsequently recoupling the first releasable fluid inlet coupling, different hydrogen gas generators, having different capacities, availabilities and/or characteristics, may be coupled to the set of hydrogen storage devices. For example, by coupling and subsequently recoupling the first releasable fluid outlet coupling, different electrical generators, such as fuel cells and/or conventional combustion electrical generators, having different capacities, efficiencies, availabilities and/or characteristics, may be coupled to the set of hydrogen storage devices. In this way, the power supply may be configured efficiently for a particular electrical power output, for example a peak electrical output, a total capacity and/or a duration of the power supply, as required for expected usage and/or demand.

### Hydrogen Storage Device

The power supply comprises the set of hydrogen storage devices, including the first hydrogen storage device, optionally the set of heaters including the first heater, the first releasable fluid inlet coupling and/or the first releasable fluid outlet coupling. In one example, the set of hydrogen storage devices includes M hydrogen storage devices, wherein M is a natural number of at least 1, for example 1, 2, 3, 4, 5, 6, 7, 8, 9, 10 or more. In this way, a hydrogen storage capacity of the power supply may be matched to a requirement, for example. In one example, the power supply is arranged to comprise an additional m hydrogen storage devices, wherein M is a natural number of at least 1, for example 1, 2, 3, 4, 5, 6, 7, 8, 9, 10 or more, for example by coupling respective first fluid inlets and the first fluid outlets to the first releasable fluid inlet coupling and/or the first releasable fluid outlet coupling, respectively. In this way, a hydrogen storage capacity of the power supply may be increased to meet an increased requirement, for example. Conversely, a hydrogen storage capacity of the power supply may be decreased to meet a decreased requirement, for example, by uncoupling surplus hydrogen storage devices. That is, the hydrogen storage capacity of the power supply may be scaled, for example up or down. In one example, the set of hydrogen storage devices comprises an inlet manifold, arranged to manifold respective first fluid inlets of the set of hydrogen storage devices. In one example, the set of hydrogen storage devices comprises an outlet manifold, arranged to manifold respective first fluid outlets of the set of hydrogen storage devices. In one example, respective hydrogen storage devices of the set of hydrogen storage devices are individually releasably coupled to the inlet manifold and/or outlet manifold. In this way, storing hydrogen to and/or releasing hydrogen from the set hydrogen storage devices may be further scaled and/or balanced. For example, a particular hydrogen storage device may be uncoupled from or coupled to the inlet manifold and/or outlet manifold, such as during operation of the power supply, without interrupting operation thereof. In one example, respective hydrogen storage devices of the set of hydrogen storage devices are individually valved, using valves as described previously, to the inlet manifold and/or outlet manifold. In this way, storage to and/or release from a selected hydrogen storage device may be controlled by selectively opening and/or closing the respective valve.

The first hydrogen storage device comprises the pressure vessel having the first fluid inlet and the first fluid outlet, wherein the first fluid inlet and/or the first fluid outlet are in fluid communication with the first releasable fluid inlet coupling and/or the first releasable fluid outlet coupling, respectively. In contrast to conventional pressure vessels for storage of compressed hydrogen gas, the pressure vessel is designed according to a relatively low operating pressure of at most 100 bar, preferably at most 75 bar, more preferably at most 50 bar, even more preferably at most 25 bar, most preferably at most 10 bar. In one example, the first hydrogen storage device is cylindrical, having dished ends. Other suitable shapes are known, depending, at least in part, on the operating pressure. For example, the first hydrogen storage device may be cuboidal such as a square based prism. In this way, the set of hydrogen storage devices may be readily stacked, for example compactly, thereby reducing a physical footprint thereof and/or facilitating transportation. It should be understood that the first fluid inlet and the first fluid outlet are for the inlet of hydrogen into the pressure vessel and outlet of hydrogen from the pressure vessel, respectively, such as provided, at least in part, by a perforation (i.e. an aperture, a passageway, a hole) through a wall of the pressure vessel. In one example, the first fluid inlet and the first fluid outlet are a gas inlet and a gas outlet, respectively. In one example, the first fluid inlet and the first fluid outlet are provided by and/or via the same perforation. In one example, the pressure vessel has a plurality of gas inlets and/or gas outlets, including the first gas inlet and the first gas outlet respectively. It should be understood that the first releasable fluid inlet coupling provides coupling thereto and uncoupling therefrom, for example repeatedly, of corresponding couplings. Suitable releasable couplings (also known as fittings or connectors) include push-fit fittings, bayonet fittings, quick connect fittings, cylinder connections to BS341 or DIN 477, hose end fittings, pipe end fittings, tube end fittings and screw fittings. Other releasable couplings are known. In one example, the power supply comprises one or more of a thermocouple, a thermowell, a valve, a flashback arrestor, a filter such as a sorbent protection filter, a pressure sensor and a mass flow controller (MFC), for example inline with the first releasable fluid inlet coupling. A valve is generally movable between an open position in which hydrogen can enter or exit the vessel, and a closed position in which the vessel is sealed. In one example, the valve is electrically and/or pneumatically actuatable. In this way, the valve may be actuated remotely, for example via a controller. In one example, the MFC is electrically actuatable. In this way, the MFC may be actuated remotely, for example via a controller, to control flow of hydrogen therethrough. The second releasable fluid inlet coupling may be as described with respect to the first releasable fluid inlet coupling, mutatis mutandis.

The pressure vessel is arranged to receive therein the hydrogen storage material in thermal contact, at least in part, with the thermally conducting network.

As an alternative to storage of hydrogen as a compressed gas or as a liquid, certain metals and alloys permit reversible storage and release of hydrogen (i.e. hydrogen storage materials). These hydrogen storage materials, due to their high hydrogen-storage efficiency, including low hydrogen loss during cycling and/or reduced heat loss between cycles (thermal efficiency), are considered superior to conventional methods of hydrogen storage. Particularly, by storing hydrogen as a solid hydride, a greater volumetric storage density may be achieved than possible for hydrogen as a compressed gas or as a liquid. In addition, hydrogen storage as a solid hydride presents a reduced safety risk compared with storing hydrogen as a compressed gas or as a liquid. In one example, the hydrogen storage material comprises and/or is a solid hydride.

For example, solid-phase metal or alloy materials can store large amounts of hydrogen by absorbing hydrogen with a high density and by forming a metal hydride under a specific temperature/pressure or electrochemical conditions, and hydrogen can be released by changing these conditions.

Generally, an efficiency of exchange of hydrogen into and out of such storage materials may be enhanced or inhibited by their respective heat transfer capabilities. Particularly, hydriding (also known as hydrogen absorption) is exothermic while dehydriding (also known as hydrogen desorption) is endothermic. Therefore, moving heat within such storage materials or maintaining preferred temperature profiles across and through volumes of such storage materials becomes a crucial factor in such metal or alloy hydride hydrogen storage materials. As a general matter, release of hydrogen from the crystal structure of a metal hydride requires input of some level of energy, normally heat. Placement of hydrogen within the crystal structure of a metal, metal alloy, or other storage system generally releases energy, normally heat, providing a highly exothermic reaction of hydriding or placing hydrogen atoms within the crystal structure of the hydrideable alloy.

The heat released from hydrogenation of hydrogen storage metals or alloys may be removed. Heat ineffectively removed can cause the hydriding process to slow down or terminate. This becomes a serious problem which prevents fast charging. During fast charging, the hydrogen storage material is quickly hydrogenated and considerable amounts of heat are produced. The hydrogen storage device described herein, particularly the thermally conducting network, provides for effective removal of the heat caused by the hydrogenation of the hydrogen storage alloys to facilitate fast charging of the hydride material. Approaches to this issue have been reported, for example in US 2003/0209149 and in “Heat transfer techniques in metal hydride hydrogen storage: A review”, Afzal et al., International Journal of Hydrogen Energy, 2017, 42(52), 30661-30682.

The hydrogen storage devices described herein allow for rapid charging and discharging of hydrogen gas while may also be relatively compact. Typically, heat is applied to discharge hydrogen gas, and heat is released and needs to be absorbed (for example, cooling applied) during hydrogen charging. The hydrogen storage devices allow for rapid heating and/or cooling, particularly via the thermally conducting network, which means less heat is wasted to the surroundings during operation, since the charging and discharging times are relatively short. The hydrogen storage devices also enable highly targeted heating, which avoids unnecessary heat loss and associated wasted energy.

The hydrogen storage material in the device of the invention can be a compound that is a metal hydride. Typically, the elemental metal reacts with hydrogen to form a metal hydride, for example:

$$Mg + {H}_{2} \to {MgH}_{2}$$

Generally, this reaction may be driven forwards by increasing hydrogen pressure.

Release of hydrogen occurs when heat is applied to the hydride. For example, for magnesium hydride and at 1 bar of pressure, MgH₂ decomposes to Mg metal and hydrogen at 287° C.:

$${MgH}_{2} \to Mg + {H}_{2}$$

In one example, the hydrogen storage material comprises one or more metal hydrides selected from MgH₂, NaAlH₄, LiAlH₄, LiH, LaNi₅H₆, TiFeH₂, palladium hydride PdHₓ, LiNH₂, LiBH₄ and NaBH₄. MgH₂, NaAlH₄, LiAlH₄, LiH and/or LaNi₅H₆ are preferred. In one example, the hydrogen storage material comprises a mixture of two or more of these metal hydrides. These different metal hydrides may have different storage and/or release rates. Hence, a mixture of two or more of these metal hydrides may be selected for desired storage and/or release rates, for example under different conditions, and/or to provide relatively more constant storage and/or release rates under a different conditions. In one example, the hydrogen storage material comprises a dopant such as a catalyst and/or an additive. For example, Ti and/or Zr may be used as catalytic dopants to improve kinetics of hydrogen storage and/or release, such as of sodium alanate. Although alkali metal alanates were known as non-reversible ‘chemical hydrides’, catalysed reversibility offers the possibility of a new family of low-temperature hydrides. For example, the alkali metal alanate-complex hydride, NaAlH₄, readily releases and absorbs hydrogen when doped with a TiCl₃ or Ti-alkoxide catalysts. There is currently ongoing research looking into optimisation of these catalysts in terms of their type, doping process and mechanistic understanding. Generally any appropriate transition or rare-earth metal can be used as catalysts, for example Ti, Zr, V, Mn, Fe, Ni, Co, Cr, Nb, Ge, Ce, La, Nd, Pd, Pr, Zn, Al, Ag, Ga, In and/or Cd. Additives include C, which improves thermal transfer of the hydrogen storage material. In one example, the hydrogen storage material is provided as particles (for example, in a powder form). In one example, the particles are microparticles, having a D50 or a D90 of at most 500 μm, at most 250 μm, at most 100 μm or at most 50 μm. In one example, the particles are microparticles having a D50 or a D10 of at least 1 μm, at least 5 μm, at least 10 μm or at least 25 μm. In one example, the particles are nanoparticles having a D50 or a D90 of at most 500 nm, at most 250 nm, at most 100 nm or at most 50 nm. In one example, the particles are nanoparticles having a D50 or a D10 of at least 1 nm, at least 5 nm, at least 10 nm or at least 20 nm. In one example, the particles are a mixture of particles of different sizes, for example a mixture of microparticles and nanoparticles, thereby having a bimodal particle size distribution. In this way, a packing efficiency for example a density and/or a surface area of the particles may be increased, thereby increasing storage of hydrogen and/or a rate of storage of hydrogen respectively. In one example, the hydrogen storage material is processed, for example by attrition such as ball milling, to reduce a particle size thereof and/or a particle size distribution thereof and/or to incorporate a dopant and/or an additive.

As an alternative to storage of hydrogen as a compressed gas or as a liquid, certain unsaturated organic compounds permit reversible storage and release of hydrogen (i.e. hydrogen storage materials). These hydrogen storage materials, due to their high hydrogen-storage efficiency, including low hydrogen loss during cycling and/or reduced heat loss between cycles (thermal efficiency), are considered superior to conventional methods of hydrogen storage. Particularly, by storing hydrogen as a LHOC, a greater volumetric storage density may be achieved than possible for hydrogen as a compressed gas or as a liquid. In addition, hydrogen storage as a LOHC presents a reduced safety risk compared with storing hydrogen as a compressed gas or as a liquid. In one example, the hydrogen storage material comprises and/or is a LOHC.

For example, unsaturated organic compounds can store large amounts of hydrogen by absorbing hydrogen with a high density and by forming saturated organic compounds under a certain temperature/pressure conditions, and hydrogen can be released by changing these conditions.

Generally, an efficiency of exchange of hydrogen into and out of such storage materials may be enhanced or inhibited by their respective heat transfer capabilities. Particularly, hydrogenation (loading of LOC to LOHC, thereby storing hydrogen) is exothermic and dehydrogenation (unloading of LOHC to LOC, thereby releasing hydrogen) is endothermic. Therefore, moving heat within such storage materials or maintaining preferred temperature profiles across and through volumes of such storage materials becomes a crucial factor in such hydrogen storage materials.

Heat ineffectively supplied or removed causes hydrogenation and dehydrogenation to slow down or terminate. This becomes a serious problem which prevents fast charging and release. During fast charging and release, considerable amounts of heat are required to heat and cool the LOC and LOHC, respectively, and particularly, should be supplied homogeneously given the relatively low thermal conductivity of LOC and LOHC. The hydrogen storage device described herein, particularly the thermally conducting network, provides for effective heating and cooling of the hydrogen storage material to facilitate fast charging and release.

The hydrogen storage devices described herein allow for rapid charging and discharging of hydrogen gas while may also be relatively compact. The hydrogen storage devices allow for rapid heating and cooling, particularly via the thermally conducting network, which means less heat is wasted to the surroundings during operation, since the charging and discharging times are relatively short. The hydrogen storage devices also enable highly targeted heating, which avoids unnecessary heat loss and associated wasted energy.

In one example, the LOHC comprises and/or is a saturated cycloalkene, aromatic, heterocyclic aromatic and/or a mixture thereof. It should be understood that LOHC generally refers to the hydrogenated (i.e. loaded, saturated) liquid organic compound while LOC generally refers to the dehydrogenated (i.e. unloaded, unsaturated) liquid organic compound. However, in practice, a given molecular name may be used interchangeably to refer to both, with the correct meaning understood by the skilled person in the given context. Hence, for example, N-ethylcarbazole (NEC) may be referred to commonly as a LOHC yet is unsaturated. Research on LOHC was initially focused on cycloalkanes, having a relatively high hydrogen capacity (6-8 wt. %) and production of COx-free hydrogen. Heterocyclic aromatic compounds (or N-Heterocycles) are also appropriate. N-Ethylcarbazole (NEC) is a well-known LOHC but many other LOHCs are known. With a wide liquid range between −39° C. (melting point) and 390° C. (boiling point) and a hydrogen storage density of 6.2 wt. %, dibenzyltoluene is ideally suited as LOHC material. Formic acid has been suggested as a promising hydrogen storage material with a 4.4 wt. % hydrogen capacity. Using LOHCs relatively high gravimetric storage densities can be reached (about 6 wt. %) and the overall energy efficiency is higher than for other chemical storage options such as producing methane from the hydrogen.

In one example, the LOHC comprises and/or is N-ethylcarbazole (NEC), monobenzyltoluene (MBT), dibenzyltoluene (DBT), 1,2-dihydro-1,2-azaborine (AB), toluene (TOL), naphthalene (NAP), benzene, phenanthrene, pyrene, pyridine, chinoline, flurene, carbazole, methanol, formic acid, phenazine, ammonia and/or mixtures thereof. Cycloalkanes reported as LOHCs include cyclohexane, methyl-cyclohexane and decalin. The dehydrogenation of cycloalkanes is highly endothermic (63-69 kJ/mol H2), which means this process requires relatively high temperatures and/or heat inputs. Dehydrogenation of decalin is the most thermodynamically favored among the three cycloalkanes, and methyl-cyclohexane is second because of the presence of the methyl group. Ni, Mo and Pt based catalysts have been investigated for dehydrogenation. However, coking is still a big challenge for catalyst's long-term stability. Generally, hydrogenation and dehydrogenation of LOHCs requires catalysts. It was demonstrated that replacing hydrocarbons by hetero-atoms, like N, O etc. improves reversible de/hydrogenation properties. The temperature required for hydrogenation and dehydrogenation drops significantly with increasing numbers of heteroatoms. Among all the N-heterocycles, the saturated-unsaturated pair of dodecahydro-N-ethylcarbazole (12H-NEC) and NEC has been considered as a promising candidate for hydrogen storage with a fairly large hydrogen content (5.8 wt %). The standard catalyst for NEC to 12H-NEC is Ru and Rh based. The selectivity of hydrogenation can reach 97% at 7 MPa and 130° C. to 150° C. Although N-heterocycles can optimize the unfavorable thermodynamic properties of cycloalkanes, challenges include relatively high cost, high toxicity and/or kinetic barriers. Use of formic acid as a hydrogen storage material has been reported. Carbon monoxide free hydrogen has been generated in a very wide pressure range (1-600 bar). A homogeneous catalytic system based on water-soluble ruthenium catalysts selectively decompose HCOOH into H₂ and CO₂ in aqueous solution. This catalytic system overcomes the limitations of other catalysts (e.g. poor stability, limited catalytic lifetimes, formation of CO) for the decomposition of formic acid making it a viable hydrogen storage material. The co-product of this decomposition, carbon dioxide, can be used as hydrogen vector by hydrogenating it back to formic acid in a second step. The catalytic hydrogenation of CO₂ has long been studied and efficient procedures have been developed. Formic acid contains 53 g L⁻¹ hydrogen at room temperature and atmospheric pressure. By weight, pure formic acid stores 4.3 wt. % hydrogen. Pure formic acid is a liquid with a flash point 69° C. However, 85% formic acid is not flammable. Ammonia (NH₃) releases H₂ in an appropriate catalytic reformer. Ammonia provides high hydrogen storage densities as a liquid with mild pressurization and cryogenic constraints: It can also be stored as a liquid at room temperature and pressure when mixed with water. Ammonia is the second most commonly produced chemical in the world and a large infrastructure for making, transporting, and distributing ammonia exists. Ammonia can be reformed to produce hydrogen with no harmful waste.

In use, during storage of hydrogen, hydrogen may be received into the first vessel of the first hydrogen storage device via the first fluid inlet, for example from a hydrogen gas generator, as described below. Preferably, the first hydrogen storage device is initially in a fully discharged state. When the hydrogen comes into contact with the hydrogen storage material, a temperature of the hydrogen storage material increases due to the exothermic absorption (i.e. hydriding) reaction of the hydrogen storage, as described previously. Heat from the exothermic reaction is conducted via the thermally conducting network, thereby attenuating the increase in the temperature. Optionally, a first cooler may be activated to further attenuate the increase in the temperature and subsequently, deactivated when a set low temperature threshold is reached (for example 20° C.). A valve inline with the first fluid inlet may be opened, to admit the hydrogen, and closed, to contain the hydrogen, for example when a pressure within the first vessel reaches, for example stabilises, at predetermined operating pressure (for example 10 bar). Depending on a type of hydrogen storage material, kinetics of absorption may be different and thus this step of storage of the hydrogen may be modified accordingly. For example, to accelerate storage of hydrogen, absorption thereof may be preferred at higher temperatures, for example of at least 100° C., to favour kinetics of hydriding.

In use, during release of hydrogen (i.e. desorption), a reverse process to storage occurs. A valve inline with the first fluid outlet may be opened, to allow exit of the hydrogen therethrough, for example to an electrical generator. As hydrogen is released from the hydrogen storage material, the temperature thereof decreases due to the endothermic desorption, as described previously. The first heater heats the thermally conducting network and hence the hydrogen storage material, for example as activated by a temperature measurement of the thermally conducting network using a thermocouple. The first heater may be deactivated once a set high temperature threshold is reached (for example 80° C.). The valve may be then closed when the pressure reaches, for example stabilises at, a predetermined pressure is reached (for example 1 bar).

In one example, the first hydrogen storage device comprises and/or is a static first hydrogen storage device. In such a static device, a predetermined volume of LOHC (for example, corresponding with at most an open volume of the first vessel) is received in the first vessel through the first fluid inlet and heated, via the thermally conducting network, thereby releasing hydrogen gas, which exits the first vessel via the first fluid outlet. When all the hydrogen is released from the LOHC, only liquid organic carrier, LOC, (i.e. unloaded LOHC) remains in the first vessel, and may be discharged (for example, for reloading) via the first fluid outlet or reloaded in the first vessel. Alternatively, in such a static device, a predetermined volume of liquid organic carrier, LOC, is received in the first vessel through the first fluid inlet together with hydrogen gas and heated and cooled, via the thermally conducting network, thereby storing the hydrogen gas in the LOC as the LOHC. When the LOC is fully loaded, only loaded LOHC remains in the first vessel. Hence, it should be understood that in the static device, the LOHC (or LOC) does not flow through the first vessel while releasing (or charging, respectively) the hydrogen. In one example, the static first hydrogen storage device comprises a mixer or stirrer, for mixing or stirring the LOHC (or LOC) therein, thereby improving an efficiency of dehydrogenation (or hydrogenation), respectively.

In contrast, in one example, the first hydrogen storage device comprises and/or is a dynamic (also known as flow-through) first hydrogen storage device. In such a dynamic device, a flow of LOHC is received, for example continuously, into the first vessel through the first fluid inlet and heated, via the thermally conducting network, thereby releasing hydrogen gas, which exits the first vessel together with the LOC (i.e. the unloaded LOHC) through the first fluid outlet. Alternatively, in such a dynamic device, a pressurised flow of LOC is received in the first vessel together with a flow of hydrogen gas and heated and cooled, via the thermally conducting network, thereby storing the hydrogen gas in the loaded LOC as the LOHC, which exits the first vessel through the first fluid outlet. Hence, it should be understood that in the dynamic device, the LOHC (or LOC) flows through the first vessel while releasing (or charging, respectively) the hydrogen. In one example, the first hydrogen storage device comprises a pump arranged to flow the hydrogen storage material through the first vessel.

In one example, the first hydrogen storage device comprises, is and/or is known as a reactor.

The pressure vessel comprises therein the thermally conducting network thermally coupled to the first heater. In one example, a face of the thermally conducting network is in thermal contact (and hence thermally coupled to) the first heater. In one example, the first heater is integrally formed with and/or in the thermally conducting network, at least in part. For example, the first heater may be embedded within (i.e. internal to) the thermally conducting network.

The thermally conducting network may be formed from any suitable thermally conducting material for example a metal such as aluminium, copper, respective alloys thereof such as brass or bronze alloys of copper and/or stainless steel. Preferred materials also do not react with and/or are not embrittled by hydrogen and/or the hydrogen storage material, while having sufficient strength to maintain a structural integrity of the thermally conducting network. In one example, the thermally conducting network comprises a coating to reduce reaction with and/or embrittlement by hydrogen.

In one example, the thermally conducting network has a lattice geometry, a gyroidal geometry and/or a fractal geometry in two and/or three dimensions (i.e. mutually orthogonal dimensions). It should be understood that such geometries comprise a plurality of nodes, having thermally conducting arms (i.e. generally elongated members) therebetween, with voids (i.e. gaps, space) between the arms. Such geometries, particularly the fractal geometry, provide relatively high surface area to volume ratios, enables especially efficient heat transfer to and from the hydrogen storage material. In one example, the fractal geometry is selected from a group consisting of a Gosper Island, a 3D H-fractal, a Quadratic Koch Island, a Quadratic Koch surface, a Von Koch surface, a Koch Snowflake, a Sierpinski carpet, a Sierpinski tetrahedron, a Mandelbox, a Mandelbulb, a Dodecahedron fractal, a Icosahedron fractal, a Octahedron fractal, a Menger sponge and a Jerusalem cube. Certain fractal geometries, such as Gosper islands, allow for a plurality of individual repeat unit blocks to be fabricated and then assembled together in a tessellation (i.e. assembled together with no overlaps or gaps). This enables a plurality of channels to be provided in the thermally conducting network through the hydrogen storage device, whereby each channel has a high surface area, is of the same construction but does not leave wasted space between repeat units. A gyroid is an infinitely connected triply periodic minimal surface, similar to the lidnoid which is also within the scope of the first aspect. The gyroid separates space into two oppositely congruent labyrinths of passages, through which the hydrogen storage material may flow. In one example, an effective density (also known as lattice volume ratio) of the lattice geometry is uniform in one, two or three dimensions (i.e. mutually orthogonal dimensions). In one example, an effective density of the lattice geometry is non-uniform in one, two or three dimensions (i.e. mutually orthogonal dimensions). It should be understood that a uniform effective density in a particular dimension provides a constant void fraction, between arms of the lattice geometry, in the particular dimension. Conversely, it should be understood that a non-uniform effective density in a particular dimension provides a non-constant void fraction, between arms of the lattice geometry, in the particular dimension. A higher effective density will lead to faster heat conduction due to a higher thermally conducting material content. For example, the effective density may increase or decrease in the particular dimension, for example radially. In this way, the thermally conducting network may be designed, for example optimised, for a particular pressure vessel geometry so as to improve, for example optimise, heat transfer to and/or from the hydrogen storage material via the thermally conducting network. In one example, an effective density of the lattice geometry is uniform in a first dimension, for example axially, and non-uniform in mutually orthogonal second and third dimensions, for example radially. While the surface area to volume ratios of lattice geometries, for example square lattice geometries such as three-dimensional cages, are relatively lower than of fractal geometries having the same volumes, forming and/or fabrication of lattice geometries is relatively less complex and/or costly and hence may be preferred. In one example, the thermally conducting network is formed, at least in part, by 3D printing (i.e. additive manufacturing), for example by selective laser melting (SLM), thereby enabling forming of complex shapes in three dimensions having internal voids, for example. In one example, the thermally conducting network is formed, at least in part, by casting, moulding such as injection moulding and extrusion. Other additive manufacturing processes are known. In one example, the thermally conducting network is formed, at least in part, by fabrication and/or machining such as milling, turning or drilling. Other subtractive manufacturing processes are known.

The power supply optionally comprises the set of heaters including the first heater. In one example, the power supply comprises the set of heaters including the first heater and the thermally conducting network is thermally coupled to the first heater. By heating the first heater, heat is transferred to the thermally conducting network thermally coupled thereto. In turn, heat is transferred to the hydrogen storage material in thermal contact, at least in part, with the thermally conducting network. In this way, the hydrogen storage material is heated by the first heater, via the thermally conducting network, thereby causing hydrogen to be released from the hydrogen storage material. In one example, the first heater is positioned inside the pressure vessel. In one example, the first heater is positioned outside of the pressure vessel. Positioning the first heater outside the pressure vessel simplifies certain aspects of the assembly of the device and allows simpler access for electrical wiring. In one example, the first heater comprises and/or is a thermoelectric heater and/or a Joule heater, and/or a recirculating heater, for example recirculating liquid, and the first vessel is arranged, for example comprising a passageway, to interchangeably receive the Joule heater and the recirculating heater therein and/or thereon. For example, the first vessel may comprise a through passageway, arranged to receive a cartridge heater inserted therein through an end of the passageway and the opposed end of the passageway may be closed, for example with an insulating plug. Alternatively, the cartridge heater and the plug may be removed and fluid couplings instead fitted to the ends, such that a recirculating liquid, such as heated coolant (i.e. a heating fluid) from a fuel cell to heat the thermally conducting network, may be pumped therethrough. In this way, flexibility for heating and/or cooling the thermally conducting network is provided. In one example, the first hydrogen storage device comprises a passageway, wherein the first hydrogen storage device is arrangeable in: a first configuration to receive a Joule heater in the passageway; and a second configuration to receive a flow of a liquid through the passageway. Other heaters are known. In one example, the power supply comprises a thermocouple connected to the first heater, for example via a proportional-integral-derivative (PID) control. In this way, a temperature of the first heater may be controlled. In one example, the first heater comprises and/or is a cartridge heater or an insertion heater. Generally, cartridge heaters are elongated cylinders including electrical resistive wire, for example embedded in magnesium oxide. Suitable cartridge heaters and insertion heaters are available from Watlow (MO, USA). In one example, the first heater is inserted into a passageway formed in and/or provided by the thermally conducting network. In one example, the first heater is integrated into the thermally conducting network, for example integrally formed therewith. In these way, a heating efficiency of the thermally conducting network is improved. In one example, the power supply comprises N heaters, including the first heater, where N is a natural number of at least 1, for example 1, 2, 3, 4, 5, 6, 7, 8, 9, 10, or more. The N heaters may be as described with respect to the first heater. In one example, the power supply comprises M hydrogen storage devices and N heaters, wherein M and N are natural numbers of at least 1 and M=N, for example M=N=1, 2, 3, 4, 5, 6, 7, 8, 9, 10 or more. In one example, the power supply comprises a battery, preferably a rechargeable battery for example a Li-ion battery, arranged to provide electrical power to the first heater. The rechargeable battery may be recharged using electrical power as provided to a set of hydrogen gas generators, as described below.

In one example, the power supply comprises a set of heater/coolers, including the set of heaters, including a first heater/cooler, comprising the first heater. By cooling the first heater/cooler, heat is transferred from the thermally conducting network thermally coupled thereto. In turn, heat is transferred from the hydrogen storage material in thermal contact, at least in part, with the thermally conducting network. In this way, the hydrogen storage material is cooled by the first heater/cooler, via the thermally conducting network, thereby allowing hydrogen to be stored in the hydrogen storage material. In other words, the first heater/cooler can, in a space-efficient manner, enable heat to be removed from the hydrogen storage material during the hydrogen storage phase, and heat to be supplied to the hydrogen storage material during hydrogen release. In one example, the first heater/cooler is positioned inside the pressure vessel. In one example, the first heater/cooler is positioned outside of the pressure vessel. Positioning the first heater/cooler outside the pressure vessel simplifies certain aspects of the assembly of the device and allows simpler access for electrical wiring. Thermoelectric heater and/or cooler devices can be very closely controlled (i.e. accurately, precisely and/or responsively), which providing control to a high degree of accuracy, precision and/or short response times. The heater of the first heater/cooler may be as described above with respect to the first heater. In one example, the cooler of the first heater/cooler comprises and/or is a heat sink, optionally with active cooling by air propelled by a fan or by a cooling fluid (e.g. water) being propelled by a pump. In one example, the first heater/cooler comprises and/or is a Peltier device or other device that makes use of thermoelectric cooling and heating. Devices of this type are commonly referred to as a Peltier heat pump, a solid state refrigerator, or a thermoelectric cooler (TEC). A thermoelectric heater and cooler device may be used together with a heat sink with optional active cooling (e.g. active cooling by air propelled by a fan or active cooling by a cooling fluid (e.g. water) being propelled by a pump). Application of heat or removal of heat on the side of the thermoelectric device that is not thermally coupled to the thermally conducting network enhances the ability of the thermoelectric device to heat and cool the thermally conducting network. In one example, the first heater/cooler (e.g. a thermoelectric heater and cooler) is in thermal contact with the thermally conducting network. As the two are in thermal contact, heat can efficiently be passed from one to the other. The heat can pass in either direction—heating the thermally conducting network or cooling it. The contact between the heater/cooler module and the thermally conducting network need not be direct physical contact. In some embodiments, there are intervening materials, such as a wall of the pressure vessel. In such an embodiment, the intervening material must continue to allow for good thermal contact between the heater/cooler module and the thermally conducting network, such that heat can pass efficiently from one to the other. Suitable thermoelectric heater and/or cooler devices are known to the person skilled in the art and they are available commercially from most electronics suppliers, such as CUI Inc (OR, USA). In one example, the hydrogen storage device comprises one or more of thermoelectric heaters and/or coolers on a base to provide a Peltier heater/cooler assembly, wherein the thermally conducting network is thermally coupled (for example, attached) to the Peltier heater/cooler assembly. For example, the thermally conducting network may be 3D printed onto the heater/cooler assembly. Optionally, foam (for example metal foam, as described below) may be attached to the thermally conducting network, for example by application of an appropriate amount of compression. Alternatively, the foam may be attached by a physical bond for example by soldering, brazing and/or welding the thermally conducting network and foam together. In such an arrangement, it is preferred for the solder and/or filler to have high thermal conductivity, which is the case for most solder and filler materials.

In one example, the hydrogen storage device comprises a thermally-conducting foam, for example a metal foam, attached to (i.e. thermally coupled to, in thermal contact with) the thermally conducting network. The inventors have found that such a foam aids heat transfer to and from the hydrogen storage material. It is known that such a foam has a high internal surface area. In one example, the foam comprises and/or is an open-celled foam, preferably an open-celled metal foam (also known as a metal sponge. Open-cell metal foams are generally manufactured by foundry or powder metallurgy. In the powder method, “space holders” are used; they occupy the pore spaces and channels. In casting processes, foam is typically cast with an open-celled polyurethane foam skeleton. The inventors have found that the hydrogen storage material may be placed in the spaces (i.e. voids, lumens, pores, cells) in the foam and the hydrogen storage material retains its ability to store and release hydrogen whilst at the same time benefiting from the enhanced rate of thermal transfer brought about by the high surface area of the foam. It should be understood that a foam pore size (i.e. cell size) is larger than a size of the hydrogen storage material, for example particles thereof. In one example, a ratio of the foam pore size to a particle size is at least 5:1, for example at least 10:1, for example 20:1, wherein sizes (i.e. foam pore size and particle size) are measurements in one dimension, for example diameter. In one example, the foam comprises and/or is a metal foam, preferably an open-celled metal foam, formed from aluminium, copper, stainless steel, nickel or zinc (or combination alloys including those metals). Aluminium foam is especially preferred. The thermally conducting network preferably contains metal foam in the spaces in the network. The voids in the metal foam contain the hydrogen storage material. It has been found that the metal foam in the fractal network provides excellent transfer of heat to and from the thermoelectric heater/cooler and the hydrogen storage material.

In one example, the pressure vessel comprises a lid (also known as a cover or a blanking plate, for example for an access hatch or an aperture in a wall of the pressure vessel) sealing coupled thereto and/or thereon, thereby providing a sealed pressure vessel around the thermally conducting network. The hydrogen storage material is advantageously added, generally in powder form, before the lid is sealing coupled to the pressure vessel. For example, if the hydrogen storage material is in powder form, the powder may be poured between arms of the thermally conducting network and optionally, into a foam to partially (i.e. at least 25%, preferably at least 35%, more preferably at least 45% by volume of voids), in a majority (i.e. at least 50%, preferably at least 60%, more preferably at least 70%, most preferably at least 80% by volume of voids), substantially (i.e. at least 90%, preferably at least 95%, more preferably at least 97.5% by volume of voids) and/or completely fill the pressure vessel. By filling the voids substantially with the powder, a hydrogen storage capacity is increased. Conversely, by filling the voids partially with the powder, heat transfer with the thermally conducting network may be improved. This filling may generally be carried out in an inert atmosphere environment, such as under argon, or other inert gas, before sealing the lid on the pressure vessel. Depending on the scale of manufacture, this may be carried out in a glove box. Slight agitation, for example vibration, can be advantageous, to ensure the powder percolates through the thermally conducting network and/or foam. In one example, the hydrogen storage device comprises an agitator, for example a vibrator, mechanically coupled to the pressure vessel and/or the thermally conductive network, arranged to agitate, for example vibrate, the pressure vessel and/or the thermally conductive network to thereby increase a filling efficiency of the pressure vessel with the hydrogen storage material.

In use, during storage of hydrogen, hydrogen may be received into the pressure vessel of the first hydrogen storage device via the first releasable fluid inlet coupling and the first fluid inlet, for example from a hydrogen gas generator, as described below. Preferably, the first hydrogen storage device is initially in a fully discharged state. When the hydrogen comes into contact with the hydrogen storage material, a temperature of the hydrogen storage material increases due to the exothermic absorption (i.e. hydriding) reaction of the hydrogen storage, as described previously. Heat from the exothermic reaction is conducted via the thermally conducting network, thereby attenuating the increase in the temperature. Optionally, a first cooler may be activated to further attenuate the increase in the temperature and subsequently, deactivated when a set low temperature threshold is reached (for example 20° C.). A valve inline with the first releasable fluid inlet coupling and/or the first fluid inlet may be opened, to admit the hydrogen, and closed, to contain the hydrogen, for example when a pressure within the pressure vessel reaches, for example stabilises, at predetermined operating pressure (for example 10 bar). Depending on a type of hydrogen storage material, kinetics of absorption may be different and thus this step of storage of the hydrogen may be modified accordingly. For example, to accelerate storage of hydrogen, absorption thereof may be preferred at higher temperatures, for example of at least 100° C., to favour kinetics of hydriding.

In use, during release of hydrogen (i.e. desorption), a reverse process to storage occurs. A valve inline with the first releasable fluid outlet coupling and/or the first fluid outlet may be opened, to allow exit of the hydrogen therethrough, for example to an electrical generator. As hydrogen is released from the hydrogen storage material, the temperature thereof decreases due to the endothermic desorption, as described previously. The first heater heats the thermally conducting network and hence the hydrogen storage material, for example as activated by a temperature measurement of the thermally conducting network using a thermocouple. The first heater may be deactivated once a set high temperature threshold is reached (for example 80° C.). The valve may be then closed when the pressure reaches, for example stabilises at, a predetermined pressure is reached (for example 1 bar).

Phase Change Materials

In one example, the first hydrogen storage device comprises a phase change material (PCM) in thermal contact, at least in part, with the thermally conducting network. In this way, heat arising during hydrogen storage may PCMs are materials having high heats of fusion and which, upon changing phase at respective phase change temperatures such as by melting and solidifying, are capable of storing and/or releasing large amounts of energy. PCMs may be classified as latent heat storage (LHS) units. Latent heat storage can be achieved through liquid-solid, solid-liquid, solid-gas and liquid-gas phase changes. However, only solid-liquid and liquid-solid phase changes are generally practical for PCMs. In one example, the PCM is a solid-liquid (and liquid-solid) PCM. In one example, the first hydrogen storage device comprises a phase change material (PCM) in thermal contact, at least in part, with the thermally conducting network. In this way, at least some of the heat arising during storage of hydrogen by the hydrogen storage material may be stored in the PCM and subsequently released therefrom, to effect at least in part release of hydrogen from the hydrogen storage material.

Consider a typical temperature profile of a solid-liquid PCM during thermal loading. Initially, below a temperature Ts, the PCM behaves as a sensible heat storage (SHS) material such that a temperature of the PCM rises as the PCM absorbs heat. Unlike conventional SHS materials, however, when the PCM reaches a phase change temperature Ts at which it changes phase (i.e. melting temperature), the PCM absorbs large amounts of heat at an almost constant temperature. The PCM continues to absorb heat without a significant rise in temperature until all the PCM is transformed to the liquid phase. When the ambient temperature around a liquid material falls, the PCM solidifies, releasing its stored latent heat. In this way, PCMs may store about 5 to about 14 times more heat per unit volume than conventional heat storage materials such as water, masonry or rock.

In one example, the PCM comprises at least one of an organic PCM, an inorganic PCM, an eutectic PCM, a hygroscopic PCM, a solid-solid PCM and a thermal composite. In selection of a PCM, one or more of the following properties may be desirable: phase change temperature in a desired operating temperature range, high latent heat of fusion per unit volume, high specific heat, high density and high thermal conductivity, small volume change on phase transformation, small vapour pressure at operating temperatures, congruent melting, high nucleation rate to avoid supercooling of a liquid phase, high rate of crystal growth, chemical stability, reversibility of phase change, absence of degradation due to phase change, non-corrosiveness, non-toxic, non-flammable, low cost and/or availability.

Organic PCMs include, for example, paraffins (CₙH₂ₙ₊₂), carbohydrates and lipid-derived materials. Beneficial properties of organic PCMs may include freezing without much undercooling, melting congruently, self-nucleation, compatibility with conventional material of construction, no or little segregation, chemically stability, high heat of fusion, safe and non-reactivity and/or recyclability. In addition, carbohydrate and lipid based PCMs may be produced from renewable sources. However, organic PCMs may have low solid thermal conductivities, require high heat transfer rates during the freezing cycle, low volumetric latent heat storage capacities and/or flammabilities. To obtain reliable phase change points, manufacturers typically provide technical grade paraffins, which are essentially paraffin mixture(s) and are completely refined of oil.

Inorganic PCMs include salt hydrates (MnH₂O), for example. Beneficial properties of inorganic PCMs may include high volumetric latent heat storage capacity, availability, low cost, sharp melting point, high thermal conductivity, high heat of fusion and/or non-flammability. However, inorganic PCMs may have high changes of volume, super cooling in solid-liquid transition and/or nucleating agents may be required.

Organic and inorganic PCMs are available from Rubitherm Technologies GmbH (Berlin, Germany), for example, having phase change temperatures in a range of from −9° C. to 90° C. Heat storage capacities of these PCMs range typically from 150 kJ/kg to 290 kJ/kg.

Eutectic PCMs include, for example, c-inorganic and inorganic-inorganic compounds. Beneficial properties of eutectic PCMs may include sharp melting point and/or improved volumetric storage density compared with organic PCMs. Hygroscopic PCMs include, for example, natural building materials such as wool insulation and earth/clay render finishes, that can absorb and release water. Solid-solid PCMs undergo solid/solid phase transitions with associated absorption and release of large amounts of heat, having latent heats comparable with solid/liquid PCMs. Nucleation may not be required to prevent supercooling. Currently the temperature range of solid-solid PCMs are available having phase change temperatures in a range of from 25° C. to 180° C.

In one example, a phase change temperature of the PCM corresponds with a desorption temperature of the hydrogen storage material, in use. For example, hydrated salt S58 (available from PCM Products Ltd, UK) has a phased change temperature of 58° C. which corresponds with a desorption temperature of lanthanum nickel (LaNi₅H₆) of 60° C.

In one example, the phase change temperature is within 20° C., preferably within 10° C., more preferably within 5° C. of a desorption temperature of the hydrogen storage material. In one example, the phase change temperature is at most 20° C., preferably at most 10° C., more preferably at most 5° C. above a desorption temperature of the hydrogen storage material. In this way, an efficiency of heat storage and release by the PCM is improved, since hysteresis is reduced.

In one example, the PCM has a heat storage capacity in a range of from 100 kJ/kg to 1000 kJ/kg, preferably of from 150 kJ/kg to 500 kJ/kg, more preferably of from 200 kJ/kg to 300 kJ/kg, for example 230 kJ/kg. Generally, higher heat storage capacities are preferable. However, the first phase change temperature of the PCM may be a determining factor in selection, thereby limiting candidate PCMs.

In one example, the PCM comprises an encapsulated PCM. Encapsulation of the PCM may be required for PCMs undergoing solid-liquid phase transformations. Example of encapsulation include macro-encapsulation, micro-encapsulation and molecular encapsulation. Macro-encapsulation with large volume containment may be unsuitable for PCMs having low thermal conductivity, since such PCMs tend to solidify at edges of the macro-encapsulation, thereby preventing effective heat transfer. Micro-encapsulation generally allows PCMs to be incorporated into construction materials, for example by coating a microscopic sized PCM with a protective coating. Molecular-encapsulation allows a very high concentration of PCM within a polymer compound. In one example, the encapsulated PCM is divided into cells. The cells may be arranged to reduce static head. Walls of the cells may provide effective heat transfer, restrict passage of water through the walls, resist leakage and/or corrosion and/or may be chemically compatible with the PCM. Cell wall material examples include stainless steel, polypropylene and polyolefin. In one example, the PCM comprises an additive arranged to increase a thermal conductivity of the PCM. Some PCMs, for example some organic PCMs, may have high heats of fusion but low thermal conductivities. By including additives within the PCM, the thermal conductivity of the PCM may be increased, thereby improving heat absorption of the PCM, for example. The additives may include, for example, particles, fibres or wires, having high thermal conductivities.

### Electrical Generator

In one example, the power supply comprises: a set of electrical generators, including a first electrical generator, configured to generate electricity using hydrogen gas, selected from a group comprising a fuel cell and an electrical generator comprising a heat engine, a second releasable fluid inlet coupling coupleable to the first releasable fluid outlet coupling, and/or a first releasable electrical outlet coupling coupleable to the first electrical outlet; wherein the first electrical generator comprises a second fluid inlet in fluid communication with the second releasable fluid inlet coupling.

In this way, electrical power may be generated by the set of electrical generators, using the hydrogen gas released from the hydrogen storage material as a fuel. It should be understood that the set of electrical generators is coupled to the set of hydrogen storage devices via the respective releasable fluid couplings. Since the set of electrical generators is releasably coupled to the set of hydrogen storage devices modularity and/or scalability with respect to the set of electrical generators is thus provided, as described previously. The second releasable fluid inlet coupling may be as described with respect to the first releasable fluid inlet coupling mutatis mutandis. Suitable releasable electrical outlet couplings (also known as connectors) include plug and socket type connectors.

In one example, the first electrical generator is an electrical generator comprising a heat engine, for example comprising an internal combustion engine arranged to combust the hydrogen and a generator, moved by the internal combustion engine. Other electrical generators and/or heat engines are known.

In one example, the first electrical generator is the fuel cell, selected from a group comprising a proton exchange membrane fuel cell, PEMFC, an alkaline fuel cell, AFC, and a phosphoric acid fuel cell, PAFC. In this way, electrical power may be generated without moving parts, compactly, at relatively low temperatures and/or efficiently. PEMFCs, also known as polymer electrolyte membrane (PEM) fuel cells, are generally constructed from membrane electrode assemblies (MEA) which include electrodes, electrolyte, catalyst and gas diffusion layers. Typically, an ink of catalyst, carbon, and electrode are deposited onto a solid electrolyte and carbon paper is hot pressed on either side to protect the inside of the cell and also act as electrodes. The fundamental part of the PEMFC is a triple phase boundary (TPB) where the electrolyte, catalyst, and reactants mix and thus where cell reactions occur. The membrane must not be electrically conductive so half reactions do not mix. Generally, operating temperatures above 100° C. are desired so the water byproduct becomes steam and water management becomes less critical in PEMFC design. Suitable PEMFCs are available from Ballard Power Systems Inc. (Burnaby, Canada) such as the FCgen and FCvelocity series, and Horizon Fuel Cell Technologies (Singapore) such as the Aerostacks and H-Series. AFCs (also known as Bacon fuel cells) are cheap to manufacture and have efficiencies of up to 70%. PAFCs use liquid phosphoric acid as an electrolyte, are CO₂ tolerant and have efficiencies of up to 70%. Since PAFCs typically operate at 150 to 200° C., expelled steam may be used for air and water heating. Suitable PAFCs are available from Doosan Fuel Cell America, Inc. (CT, USA) and Fuji Electric Co. Ltd (Tokyo, Japan).

In one example, the power supply comprises: a set of hydrogen gas generators, including a first hydrogen gas generator configured to generate hydrogen gas, a third releasable fluid inlet coupling and/or a second releasable fluid outlet coupling coupleable to the first releasable fluid inlet coupling.

In this way, hydrogen may be generated by the set of hydrogen gas generators and stored in the hydrogen storage material in the set of hydrogen storage devices. It should be understood that the set of hydrogen gas generators is coupled to the set of hydrogen storage devices via the respective releasable fluid couplings. Since the set of hydrogen gas generators is releasably coupled to the set of hydrogen storage devices, modularity and/or scalability with respect to the set of hydrogen gas generators is thus provided, as described previously. The third releasable fluid inlet coupling may be as described with respect to the first releasable fluid inlet coupling mutatis mutandis. The second releasable fluid outlet coupling may be as described with respect to the first releasable fluid outlet coupling mutatis mutandis.

In one example, the first hydrogen gas generator comprises an electrolysis cell selected from a group comprising an alkaline electrolysis cell and a proton exchange membrane, PEM, electrolysis cell. In comparison with PEM electrolysis cells, alkaline water electrolysis cells typically use cheaper catalysts (compared to the platinum metal group based catalysts used for PEM water electrolysis), have higher durabilities due to an exchangeable electrolyte and lower dissolution of anodic catalyst and/or provide higher gas purities due to lower gas diffusivity in alkaline electrolyte. Conversely, PEM electrolysis cells may operate at higher current densities, thereby reducing operational costs, especially for PEM electrolysis cells coupled to very dynamic energy sources such as wind or solar, where sudden spikes in energy input would otherwise result in uncaptured energy.

In one example, the first hydrogen gas generator comprises a methane reformer. Generally, methane reformers are based on steam reforming, autothermal reforming or partial oxidation for producing hydrogen gas from methane using a catalyst. In one example, the methane reformer is selected from a group comprising a steam methane reformer (SMR) and an autothermal reformer (ATR). Steam reforming (SR), sometimes referred to as steam methane reforming (SMR) uses an external source of hot gas to heat tubes in which a catalytic reaction takes place that converts steam and lighter hydrocarbons such as methane, biogas or refinery feedstock into hydrogen and carbon monoxide (syngas). Syngas reacts further to give more hydrogen and carbon dioxide in the reactor. The carbon oxides are removed before use by means of pressure swing adsorption (PSA) with molecular sieves for the final purification. The PSA works by adsorbing impurities from the syngas stream to leave a pure hydrogen gas. Autothermal reforming (ATR) uses oxygen and carbon dioxide or steam in a reaction with methane to form syngas. The reaction takes place in a single chamber where the methane is partially oxidized. The reaction is exothermic due to the oxidation. When the ATR uses carbon dioxide the H2:CO ratio produced is 1:1; when the ATR uses steam the H2:CO ratio produced is 2.5:1.

In one example, the power supply has a first electrical inlet coupleable to the first hydrogen gas generator and/or the first electrical outlet is coupleable to the first hydrogen gas generator. In this way, electrical power may be provided to the first hydrogen gas generator and more generally, to the set of hydrogen gas generators, for example from renewable and/or excess renewable energy sources such as wind, solar, tidal and/or geothermal, from surplus conventional energy sources and optionally, from the electrical output of the power supply. Preferably, this electrical power is from excess renewable energy sources, such as available due to stronger and/or longer winds, more and/or more intense sunshine and/or stronger and/or longer tides. In this way, this excess electrical power (i.e. excess to current demand) is thus effectively stored as chemical energy in the stored hydrogen gas, thereby banking the excess electrical power.

In one example, the power supply is arrangeable in: a first arrangement, wherein the first hydrogen gas generator, the first hydrogen storage device and the first electrical generator are mutually uncoupled; and a second arrangement, wherein the first hydrogen gas generator and the first electrical generator are fluidically coupled via the first hydrogen storage device. In this way, modularity and/or scalability of the power supply is provided, as described previously.

In one example, the power supply comprises: a housing comprising a set of walls, including a first wall, arranged to house the set of hydrogen storage devices and having the first electrical outlet through the first wall. In this way, the power supply may be provided as a standalone power supply, for installation at a remote site, for example, while the housing provides protection from weather, for example. Furthermore, the housing may protect the power supply during transportation and/or in use. In one example, the housing comprises and/or is an intermodal freight container (also known colloquially as a shipping container), such as a 20′ (˜6 m) or a 40′ (˜12 m) intermodal freight container. In this way, the power supply may be readily stored, transported and/or installed, using standard storage, transportation and/or lifting means, thereby reducing cost and/or complexity. In one example, the housing comprises a set of wheels. In this way, transportation of the power supply is facilitated. In one example, the housing comprises a set of lifting lugs or points for a lifting bridle and/or a set of forklift pockets.

In one example, the power supply comprises: a controller configured to control the first heater based, at least in part, on a rate of electrical energy output via the first electrical outlet. In this way, a rate of release of the hydrogen from the hydrogen storage material may be controlled responsive to the rate of usage of electrical power. For example, if the rate of usage of electrical power increases, the heater may be heated further, for example to a higher temperature, to increase the rate of release of the hydrogen from the hydrogen storage material. Conversely, if the rate of usage of electrical power decreases, the heater may be heated less, for example to a lower temperature, to decrease the rate of release of the hydrogen from the hydrogen storage material. In this way, the rate of release of the hydrogen from the hydrogen storage material may be matched to the rate of usage of electrical power, thereby improving an efficiency of generation of electrical power, since surplus electrical power may be avoided.

In one example, the controller is configured to control the first heater based, at least in part, on a predicted rate of electrical energy output via the first electrical outlet. In this way, release of hydrogen from the hydrogen storage material may be pre-emptively controlled, for example increased, so as to fulfil the predicted rate of electrical energy, thereby reducing latency of the release of the hydrogen. Conversely, release of hydrogen from the hydrogen storage material may be pre-emptively controlled, for example decreased, so as to still fulfil the predicted rate of electrical energy, thereby reducing surplus electrical energy generation. In one example, the controller is configured to control the set of heaters, as described with respect to the first heater, collectively and/or independently. In this way, respective heaters of the first set of heaters may be controlled in unison and/or individually, thereby improving granularity of control.

In one example, the controller is configured to control a cooler, as described previously, based, at least in part, on a predicted rate of electrical energy output via the first electrical outlet. In this way, release of hydrogen from the hydrogen storage material may be pre-emptively controlled, as described with respect to the first heater mutatis mutandis.

In one example, the controller is configured to control the set of electrical generators, including the first electrical generator, based, at least in part, on a rate and/or a predicted rate of electrical energy output via the first electrical outlet. In this way, the rate of electrical energy generation may be matched to the rate and/or the predicted rate of usage of electrical power, thereby improving an efficiency of generation of electrical power, since surplus electrical power may be avoided.

In one example, the controller is configured to control the set of hydrogen gas generators, including the first hydrogen gas generator, based, at least in part, on a rate and/or a predicted rate of electrical energy output via the first electrical outlet and/or based on a rate and/or a predicted rate of hydrogen release from the hydrogen storage material and/or an amount of hydrogen stored by the hydrogen storage material and/or on an availability of energy for electrolysis. The rate of hydrogen release and/or the amount of hydrogen stored may be determined, calculated and/or measured from a pressure and/or pressure change of the set of hydrogen storage devices, including the first hydrogen storage device and/or from a mass flow measurement of hydrogen therefrom, for example using a pressure gauge and/or a MFC. In this way, the rate of hydrogen gas generation may be matched to the rate and/or the predicted rate of usage of electrical power and/or the availability of energy for electrolysis, thereby improving an efficiency of generation of electrical power, since surplus output electrical power may be avoided while advantage may be taken of the availability of energy for electrolysis.

In one example, the controller is configured to control the set of hydrogen gas generators, including the first hydrogen gas generator, the set of heaters, including the first heater, optionally the set of heater/coolers comprising the set of heaters, including the first heater, and the set of electrical generators, including the first electrical generator based, at least in part, on a rate and/or a predicted rate of electrical energy output via the first electrical outlet, for example holistically, thereby optimizing hydrogen gas generation, hydrogen storage, hydrogen release and/or electrical power generation. For example, if an amount of energy from renewable sources increases, release of hydrogen from specific hydrogen storage devices may be prioritised to fully discharge these hydrogen storage devices, electrolysis of hydrogen gas may be increased and hydrogen stored in these previously discharged hydrogen storage devices. In this way, advantage may be taken of the availability of energy for electrolysis while optimizing the amount of hydrogen stored.

In one example, the controller is configured to determine, for example calculate or estimate, a predicted rate of electrical energy output (i.e. predicted electrical power demand). For example, the controller may determine the predicted rate of electrical energy output by learning energy requirements of a user of the power supply, for example by applying machine learning algorithms to the user's energy usage. In one example, the controller is configured to obtain the energy requirements of the user from a database, such as via the internet, by measuring the user's energy usage and/or from the user.

In one example, the controller is configured to determine, for example calculate or estimate, a predicted rate of electrical energy input for hydrogen gas generation, for example from previous use information (i.e. historical data), user input (e.g. user requirements) and/or online databases (static and/or dynamically updated e.g. live updates). For example, if electrical energy for hydrogen gas generation is obtained from renewable sources, the controller may determine the predicted rate of electrical energy input from location (i.e. geographic location) information of the power supply and/or the renewable sources, including latitude, longitude and/or altitude, from climate information (i.e. seasonal weather patterns) at the respective locations of the power supply and/or the renewable sources and/or weather forecast information for the respective locations of the power supply and/or the renewable sources. In one example, the controller is configured to obtain the location information, the climate information and/or the weather forecast information from a database, such as via the internet, and/or from a user.

In one example, the controller is configured to iteratively determine the predicted rate of electrical energy output and/or the predicted rate of electrical energy input for hydrogen gas generation, for example using a feedback loop,

In one example, the controller is configured to determine, for example calculate or estimate, the predicted rate of electrical energy output and/or the predicted rate of electrical energy input for hydrogen gas generation using a generalized linear model (GLM), a random forest, logistic regression, a support vector machine, K-nearest neighbours, a decision tree, AdaBoost, XGBoost, a neural network for example a convolutional neural network, time-series classification, a recurrence plot, a linear mixed model, or an ensemble of two or more thereof. XGBoost and GLM are preferred. For example, the controller may comprise a computer device including 32×2.4 GHz processors and 32 GB RAM and computations may be performed with R using GLM and/or XGBoost; alternatively and/or additionally with Python, using Keras, Theanos and/or TensorFlow.

In this way, by determining a predicted rate of electrical energy output and/or a predicted rate of electrical energy input for hydrogen gas generation, the controller may provide ‘smart metering’, thereby controlling the power supply dynamically, responsive to changes in the electrical energy output and/or the electrical energy input for hydrogen gas generation, for example using a feedback loop. In this way, the rate of hydrogen gas generation may be matched to the rate and/or the predicted rate of usage of electrical power and/or the availability of energy for electrolysis, thereby improving an efficiency of generation of electrical power, since surplus output electrical power may be avoided while advantage may be taken of the availability of energy for electrolysis.

### Method

The second aspect provides a method of controlling a power supply comprising a set of hydrogen gas generators, including a first hydrogen gas generator, a set of hydrogen storage devices, including a first hydrogen storage device, optionally a set of heaters including a first heater, a set of electrical generators, including a first electrical generator and a controller; wherein the first hydrogen storage device comprises: a pressure vessel, having a first fluid inlet and a first fluid outlet, comprising therein a thermally conducting network optionally thermally coupled to the first heater, wherein the pressure vessel is arranged to receive therein a hydrogen storage material in thermal contact, at least in part, with the thermally conducting network, and preferably, wherein the thermally conducting network has a lattice geometry, a gyroidal geometry and/or a fractal geometry in two and/or three dimensions; wherein the method comprises: generating, by the first hydrogen gas generator, hydrogen gas; storing, by the first hydrogen storage device, the generated hydrogen gas; releasing, at least in part, the stored hydrogen gas optionally comprising controlling, by the controller, the first heater to release, at least in part, the stored hydrogen gas; and generating, by the first electrical generator, electrical energy using the released hydrogen gas.

The set of hydrogen gas generators, including the first hydrogen gas generator, the set of hydrogen storage devices, including the first hydrogen storage device, the set of heaters including the first heater, the set of electrical generators, including the first electrical generator and the controller, the pressure vessel, the first fluid inlet, the first fluid outlet, the thermally conducting network and/or the hydrogen storage material may be as described with respect to the first aspect.

In one example, the method comprises: controlling, by the controller, the first heater based, at least in part, on a rate of electrical energy generation by the first electrical generator. In this way, release of hydrogen from the hydrogen storage material may be pre-emptively controlled, as described with respect to the first aspect.

In one example, the method comprises: controlling, by the controller, the first heater based, at least in part, on a predicted rate of electrical energy generation by the first electrical generator. In this way, release of hydrogen from the hydrogen storage material may be pre-emptively controlled, as described with respect to the first heater mutatis mutandis.

In one example, the method comprises: controlling, by the controller, a rate of hydrogen gas generated by the first hydrogen gas generator based, at least in part, on a rate of electrical energy generation by the first electrical generator. In this way, generation of hydrogen gas may be pre-emptively controlled, as described with respect to the first heater mutatis mutandis.

In one example, the method comprises: controlling, by the controller, cooling of the hydrogen storage material base, at least in part, on a predicted rate of electrical energy output via the first electrical outlet. In this way, release of hydrogen from the hydrogen storage material may be pre-emptively controlled, as described with respect to the first heater mutatis mutandis.

In one example, the method comprises: controlling, by the controller, the set of electrical generators, including the first electrical generator, based, at least in part, on a rate and/or a predicted rate of electrical energy output via the first electrical outlet. In this way, the rate of electrical energy generation may be matched to the rate and/or the predicted rate of usage of electrical power, as described with respect to the first aspect.

In one example, method comprises controlling the set of hydrogen gas generators, including the first hydrogen gas generator, based, at least in part, on a rate and/or a predicted rate of electrical energy output via the first electrical outlet and/or based on a rate and/or a predicted rate of hydrogen release from the hydrogen storage material and/or an amount of hydrogen stored by the hydrogen storage material and/or on an availability of energy for electrolysis. In this way, the rate of hydrogen gas generation may be matched to the rate and/or the predicted rate of usage of electrical power and/or the availability of energy for electrolysis, as described with respect to the first aspect

In one example, method comprises controlling, by the controller, the set of hydrogen gas generators, including the first hydrogen gas generator, the set of heaters, including the first heater, optionally the set of heater/coolers comprising the set of heaters, including the first heater, and the set of electrical generators, including the first electrical generator based, at least in part, on a rate and/or a predicted rate of electrical energy output via the first electrical outlet, for example holistically, thereby optimizing hydrogen gas generation, hydrogen storage, hydrogen release and/or electrical power generation.

### CRM

The third aspect provides a tangible non-transient computer-readable storage medium having recorded thereon instructions which when implemented by a computer device comprising a processor and a memory, cause the computer device to perform a method according to the second aspect.

### BRIEF DESCRIPTION OF THE DRAWINGS

For a better understanding of the invention, and to show how example embodiments may be carried into effect, reference will now be made to the accompanying drawings in which:

FIG. 1 is a schematic view of a power supply according to an exemplary embodiment;

FIG. 2 is a schematic view of the power supply of FIG. 1, in more detail;

FIG. 3 is a schematic flow diagram of a method according to an exemplary embodiment;

FIG. 4 is a schematic flow diagram of a method of FIG. 3, in more detail;

FIG. 5 is a schematic flow diagram of a method of FIG. 3, in more detail;

FIG. 6A is a schematic axial cross-section of a hydrogen storage device for a power supply according to an exemplary embodiment and FIGS. 6B to 6D are schematic transverse cross-sections of the hydrogen storage device of FIG. 6A;

FIGS. 7A to 7C schematically depict thermally conducting networks for a hydrogen storage device for a power supply according to an exemplary embodiment;

FIG. 8A is a photograph of a foam for a hydrogen storage device for a power supply according to an exemplary embodiment; and FIG. 8B is a schematic view of a hydrogen storage device for a power supply according to an exemplary embodiment, in more detail;

FIG. 9A is a plan elevation view of a hydrogen storage device for a power supply according to an exemplary embodiment; and FIG. 9B is a side cross-sectional view of the hydrogen storage device of FIG. 9A;

FIG. 10 is CAD cutaway perspective view of a hydrogen storage device for a power supply according to an exemplary embodiment;

FIG. 11 is CAD axial cross-section of the hydrogen storage device of FIG. 10;

FIG. 12 is a CAD radial cross-section of the hydrogen storage device of FIG. 10;

FIG. 13 is an alternative CAD radial cross-section of the hydrogen storage device of FIG. 10;

FIG. 14 is a CAD perspective view of a first heater for a hydrogen storage device for a power supply according to an exemplary embodiment;

FIG. 15 is a cutaway perspective view of a first heater for a hydrogen storage device for a power supply according to an exemplary embodiment;

FIG. 16 is a cutaway perspective view of a first heater for a hydrogen storage device for a power supply according to an exemplary embodiment;

FIG. 17A is a cutaway perspective view of a hydrogen storage device for a power supply according to an exemplary embodiment; and FIG. 17B is a cutaway perspective exploded view of a related hydrogen storage device;

FIG. 18 is a cutaway perspective view of a hydrogen storage device for a power supply according to an exemplary embodiment; and

FIG. 19A is a CAD partial cutaway perspective view of a hydrogen storage device for a power supply according to an exemplary embodiment; FIG. 19B is a CAD longitudinal perspective cross-sectional view of the hydrogen storage device; and FIG. 19C is a CAD perspective view of the thermally conducting network, in more detail.

### DETAILED DESCRIPTION

At least some of the following examples provide a power supply and a method of controlling such a power supply. Many other advantages and improvements will be discussed in more detail herein.

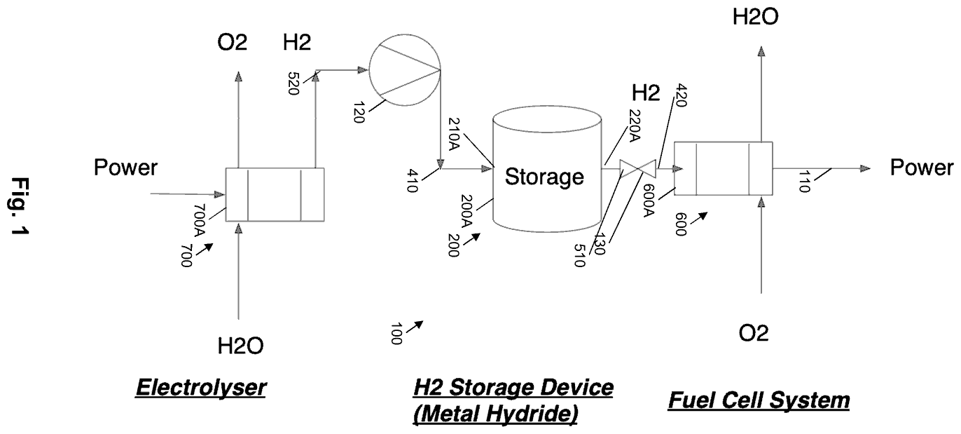

FIG. 1 is a schematic view of a power supply 100 according to an exemplary embodiment. The power supply 100 has a first electrical outlet 110 and comprises: a set of hydrogen storage devices 200 including a first hydrogen storage device 200A, optionally a set of heaters 300 (not shown), including a first heater 300A (not shown), a first releasable fluid inlet coupling 410 and/or a first releasable fluid outlet coupling 510; wherein the first hydrogen storage device 200A comprises: a pressure vessel 230A, having a first fluid inlet 210A and a first fluid outlet 220A, comprising therein a thermally conducting network 240A (not shown) optionally thermally coupled to the first heater 300A, wherein the pressure vessel 230A is arranged to receive therein a hydrogen storage material 250A (not shown) in thermal contact, at least in part, with the thermally conducting network 240A, wherein the first fluid inlet 210A and/or the first fluid outlet 220A are in fluid communication with the first releasable fluid inlet coupling 410 and/or the first releasable fluid outlet coupling 510, respectively; and preferably, wherein the thermally conducting network 240A has a lattice geometry, a gyroidal geometry and/or a fractal geometry in two and/or three dimensions.

In this example, the power supply 100 comprises: a set of electrical generators 600, including a first electrical generator 600A, configured to generate electricity using hydrogen gas, selected from a group comprising a fuel cell and an electrical generator comprising a heat engine, a second releasable fluid inlet coupling 420 coupleable to the first releasable fluid outlet coupling 510, and/or a first releasable electrical outlet coupling coupleable to the first electrical outlet 110; wherein the first electrical generator 600A comprises a second fluid inlet in fluid communication with the second releasable fluid inlet coupling. In this example, the first electrical generator 600A is the fuel cell, selected from a group comprising a proton exchange membrane fuel cell, PEMFC, an alkaline fuel cell, AFC, and a phosphoric acid fuel cell, PAFC.

In this example, the power supply 100 comprises: a set of hydrogen gas generators 700, including a first hydrogen gas generator 700A configured to generate hydrogen gas, a third releasable fluid inlet coupling 430 and/or a second releasable fluid outlet coupling 520 coupleable to the first releasable fluid inlet coupling. In this example, the first hydrogen gas generator 700A comprises an electrolysis cell selected from a group comprising an alkaline electrolysis cell and a proton exchange membrane, PEM, electrolysis cell.

In this example, the power supply 100 comprises: a controller 800 (not shown) configured to control the first heater 300A based, at least in part, on a rate and/or a predicted rate of electrical energy output via the first electrical outlet 110.

In this example, the power supply 100 comprises a pump 120, arranged to pump hydrogen from the set of hydrogen gas generators 700 into the set of hydrogen storage devices 200 and thereby increase a pressure due to the hydrogen therein. In this example, the power supply 100 comprises a gate valve 130, arranged to isolate the set of hydrogen storage devices 200 from the set of electrical generators 600.

In use, the gate valve 130 is closed and hydrogen generated by the set of hydrogen gas generators 700 is pumped, by the pump 120, into the set of hydrogen storage devices 200 and stored therein, as described previously. During storage, heat released by the hydrogen storage material 250A may be transferred out of the first hydrogen storage device 200A via the thermally conducting network 240A, as described previously. Subsequently, following hydrogen storage, the gate valve 130 is opened and the stored hydrogen released from the hydrogen storage material 250A moves to the set of electrical generators 600, whereupon chemical energy of the released hydrogen is converted into electrical energy, output via the first electrical outlet 110, as described previously. During release of the hydrogen from the hydrogen storage material 250A, heat is provided to the hydrogen storage material 250A from the set of heaters 300 via the thermally conducting network 240A, as described previously.

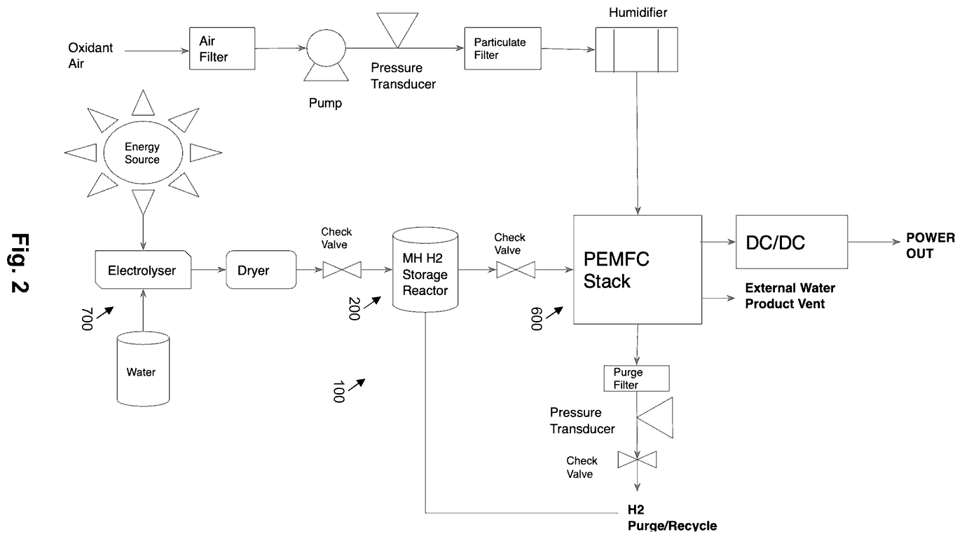

FIG. 2 is a schematic view of the power supply of FIG. 1, in more detail.

In use, water is electrolysed by the set of hydrogen gas generators 700, with electrical energy for the electrolysis obtained from solar panels (i.e. a renewable energy source). Generated hydrogen is dried and admitted, via a check valve to ensure unidirectional flow, to the set of hydrogen storage devices 200 and stored therein, as described previously.

Air (oxidant) is filtered by an air filter, pumped by the pump 120 via a pressure transducer and a particulate filter for particulate matter into a humidifier and hence to the set of electrical generators 600. Particularly, the pressure transducer records the pressure and the stream is re-filtered in another filter. The air is then humidified before entering the Proton Exchange Membrane Fuel Cell (PEMFC) (i.e. the set of electrical generators 600). Unused hydrogen exits the set of electrical generators 600 along with water vent. This unused hydrogen is filtered for particulate matter. Water is vented and unused hydrogen is sent back to the set of hydrogen storage devices 200 (not shown).

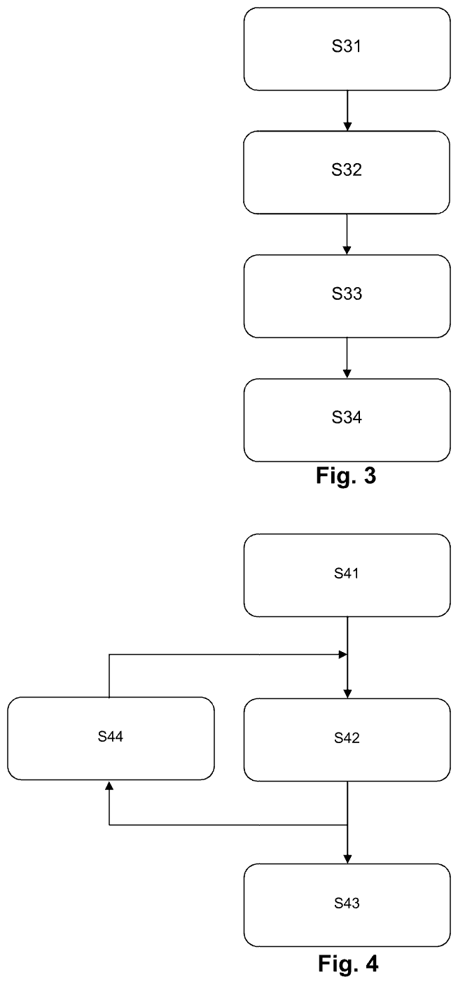

FIG. 3 is a schematic flow diagram of a method according to an exemplary embodiment. The method is of controlling a power supply comprising a set of hydrogen gas generators, including a first hydrogen gas generator, a set of hydrogen storage devices, including a first hydrogen storage device, optionally a set of heaters including a first heater, a set of electrical generators, including a first electrical generator and a controller; wherein the first hydrogen storage device comprises: a pressure vessel, having a first fluid inlet and a first fluid outlet, comprising therein a thermally conducting network optionally thermally coupled to the first heater, wherein the pressure vessel is arranged to receive therein a hydrogen storage material in thermal contact, at least in part, with the thermally conducting network, and preferably, wherein the thermally conducting network has a lattice geometry, a gyroidal geometry and/or a fractal geometry in two and/or three dimensions.

At S31, the first hydrogen gas generator generates hydrogen gas.

At S32, the first hydrogen storage device stores the generated hydrogen gas.

At S33, the stored hydrogen gas is, at least in part, released, optionally by the controller controlling the first heater to release, at least in part, the stored hydrogen gas.

At S34, the first electrical generator generates electrical energy using the released hydrogen gas.

The method may include any of the steps described with respect to the first aspect and/or the second aspect.

FIG. 4 is a schematic flow diagram of a method of FIG. 3, in more detail.

The power supply 100 may use smart metering, as described previously, in order to predict and supply the expected fuel or power to the output or to each of the three subsystems (i.e. the set of hydrogen gas generators, the set of hydrogen storage devices and the set of electrical generators), as described previously, for example under a feedback control loop as shown in FIG. 4.

The input energy data can either come from the user, or from database of information on the internet. The smart meter allows for comparison between desired/required output and supplied information. This results in a feedback loop that changes the process variables (flow, temperature, pressure) to meet required output.

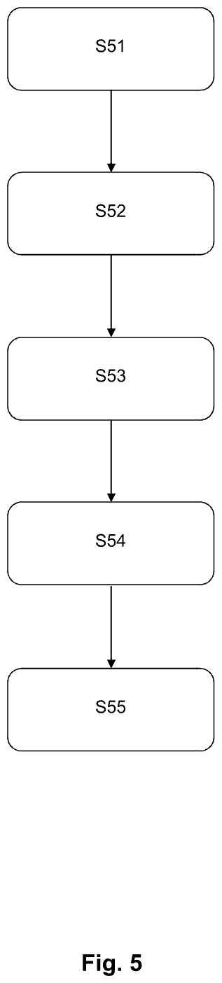

FIG. 5 is a schematic flow diagram of a method of FIG. 3, in more detail.

At S51, the controller analyses energy sink/usage.

At S52, the controller sets a quota for energy use.

At S53, the controller sets a schedule for energy use.

At S54, the controller monitors energy delivery.

At S55, the controller provides an alert if the energy use approaches 90% of the quota.

The smart metering system allows for the usage statistics to come either from the user and/or other supplied data. This then sets the expected quote of energy usage. Subsequently, the process is tailored according to power requirement schedule. The system also monitors energy usage according to the feedback system. Action is taken once energy approaches 90% of expected amount.

The communication protocol may be ZigBee, GPRS/GSM, Wi-Fi or PLC. This will be tailored to each bespoke system as required. Alternatively, PLC standard may be used throughout with appropriate systems in place according to their relevant standard.

### Example 1: Hydrogen Storage Device

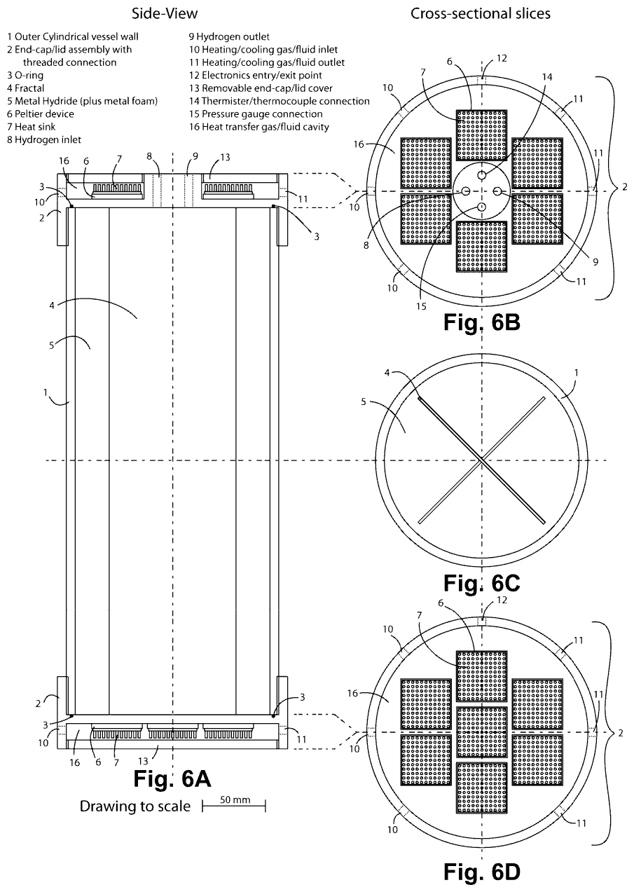

FIG. 6A is a schematic axial cross-section of a hydrogen storage device 200 for a power supply 100 according to an exemplary embodiment and FIGS. 6B to 6D are schematic transverse cross-sections of the hydrogen storage device 200 of FIG. 6A

FIG. 6 shows a hydrogen storage device 200 for the power supply 100. The hydrogen storage device 200 comprises a hollow metal cylinder (outer cylindrical vessel wall (1)) and along with two metallic end-caps (2), providing the pressure vessel. Inside this volume exists the hydrideable metal/metal alloy (5), an aluminium fractal structure (4) with metallic foam in contact with it (not shown in figure). Both end-caps (2) contain an internal cavity for the location of multiple peltier devices (6) and heat/cold sinks (7). In the outer cylindrical vessel wall (1), there are three gas inlets (10) and three gas outlets (11) allow for heating/cooling gas (air) access to this internal cap cavity to add/remove heat. There is also an electronic entry/exit point (12) in the outer cylindrical vessel wall (1). In one of the end-caps four ports (holes) are included, allowing access into the pressure vessel; they are a hydrogen gas inlet (8), a hydrogen gas outlet (9), a pressure sensor connection (15) and a temperature sensor connection (14). The end-caps are held in place and form a seal through a thread and o-ring arrangement (3). The end-caps can be removed for easy access to the pressure vessel. The end-caps have covers (13) which can be removed for easy access to the heating/cooling gas containment volume within them. That is, the hydrogen storage device 200 comprises the pressure vessel 1, having the first fluid inlet 8 and the first fluid outlet 9, comprising therein a thermally conducting network 4 optionally thermally coupled to the first heater (not shown), wherein the pressure vessel 1 is arranged to receive therein a hydrogen storage material (not shown) in thermal contact, at least in part, with the thermally conducting network 4, wherein the first fluid inlet 8 and/or the first fluid outlet 9 are in fluid communication with the first releasable fluid inlet coupling (not shown) and/or the first releasable fluid outlet coupling (not shown), respectively; and preferably, wherein the thermally conducting network 4 has a lattice geometry, a gyroidal geometry and/or a fractal geometry in two and/or three dimensions.

### Example 2: Structure Shapes for Thermally Conducting Network

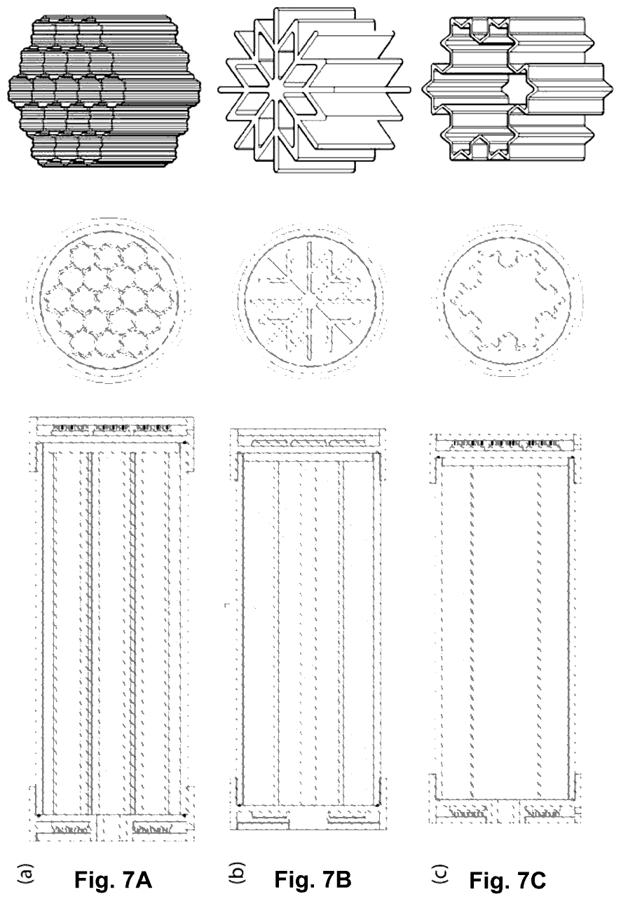

FIGS. 7A to 7C schematically depict thermally conducting networks for a hydrogen storage device for a power supply according to an exemplary embodiment.

FIG. 7 shows there are shown three alternative fractal networks (A) Gosper Island; (B) ‘Snowflake’ design; and (C) Koch Snowflake for the thermally conducting network of the hydrogen storage device 200. The 2D radially symmetric fractal patterns extend axially. Axial cross-sections, midpoint radial cross-sections and perspective views for the fractal networks are shown.

### Example 3: Metal Foam

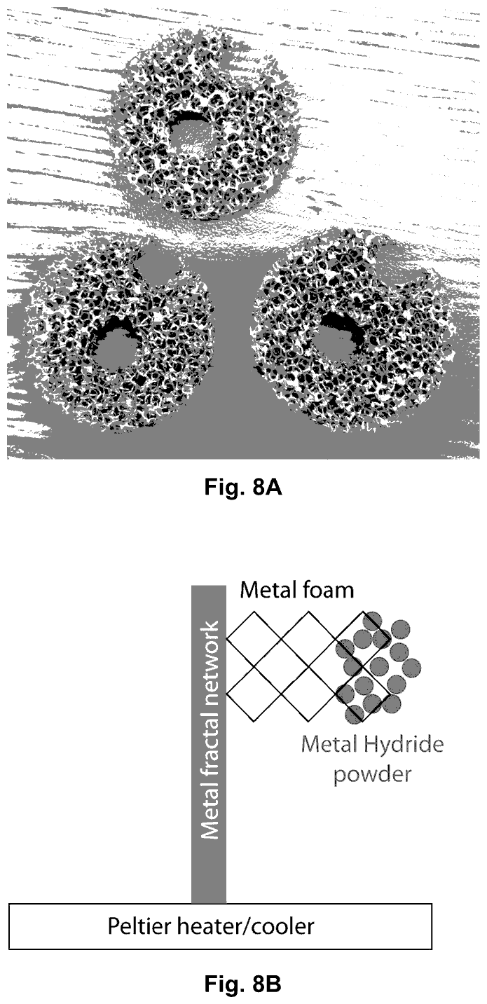

FIG. 8A is a photograph of a foam for a hydrogen storage device for a power supply according to an exemplary embodiment; and FIG. 8B is a schematic view of a hydrogen storage device for a power supply according to an exemplary embodiment, in more detail.

FIG. 8A shows a photograph of voids (i.e. open space) in a metal foam, particularly aluminium foam. The aluminium foam is produced from 6101 aluminium alloy, retaining 99% purity of the parent alloy. The foam has a reticulated structure in which cells (i.e. pores) are open and have a dodecahedral shape. The foam has a bulk density of 0.2 g/cm³; a porosity of 93% porosity and about 8 pores/cm.

FIG. 8B schematically depicts a metal hydride powder included and/or in contact with a metal foam which in turn is thermally coupled to a thermally conducting network.

### Example 4: Compact Design of Hydrogen Storage Device

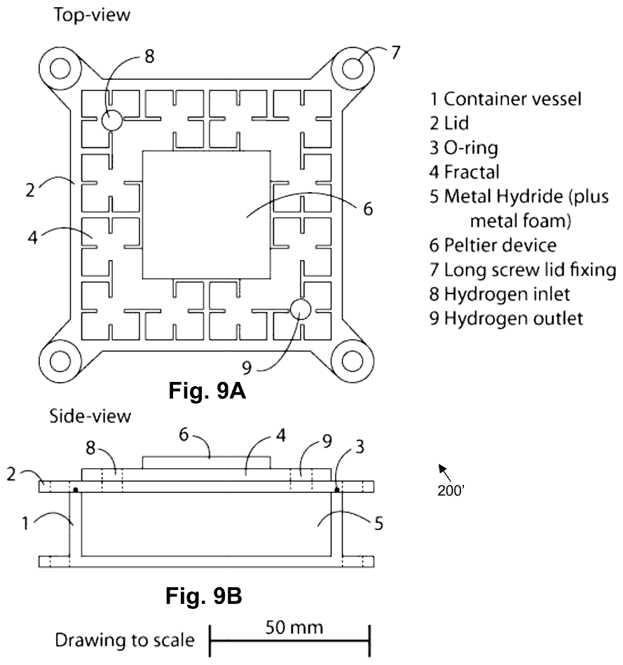

FIG. 9A is a plan elevation view of a hydrogen storage device 200′ for a power supply according to an exemplary embodiment and FIG. 9B is a side cross-sectional view of the hydrogen storage device 200′ of FIG. 9A.

FIGS. 9A and 9B schematically depict a compact design of a hydrogen storage device 200′. The hydrogen storage device 200′ comprises a hydrogen gas containment volume formed from a cuboid-based container vessel (1) with square-planar lid (2). The lid (2) is secured through the use of four axial-corner screws in screw fixings (7) and it is sealed by an O-ring (3) positioned between the vessel (1) and the lid (2). The hydrogen containment volume has within it a hydrideable metal/metal alloy (5) and metal foam (not shown). On one surface there is a thermally conducting network (4) having a flat square-based fractal geometry, that acts to dissipate heat radially. A Peltier device (6), thermally coupled to the thermally conducting network (4) and outside of the vessel (1) acts as a heater/cooler. Two holes (8) and (9) located through the lid (2) and the thermally conducting network (4) act as a hydrogen gas inlet (8) and outlet (9), respectively. That is, the hydrogen storage device 200′ comprises the pressure vessel 1, having the first fluid inlet 8 and the first fluid outlet 9, comprising therein a thermally conducting network 4 optionally thermally coupled to the first heater (not shown), wherein the pressure vessel 1 is arranged to receive therein a hydrogen storage material (not shown) in thermal contact, at least in part, with the thermally conducting network 4, wherein the first fluid inlet 8 and/or the first fluid outlet 9 are in fluid communication with the first releasable fluid inlet coupling (not shown) and/or the first releasable fluid outlet coupling (not shown), respectively; and preferably, wherein the thermally conducting network 4 has a lattice geometry, a gyroidal geometry and/or a fractal geometry in two and/or three dimensions.

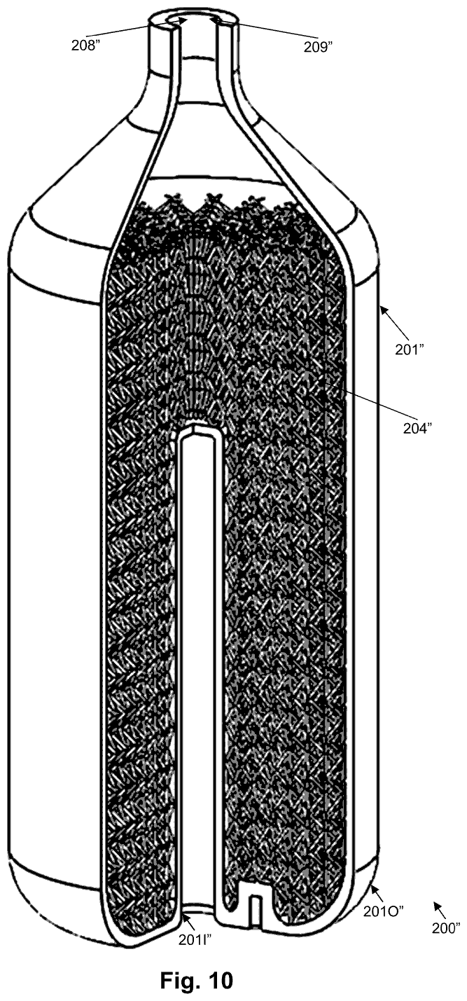

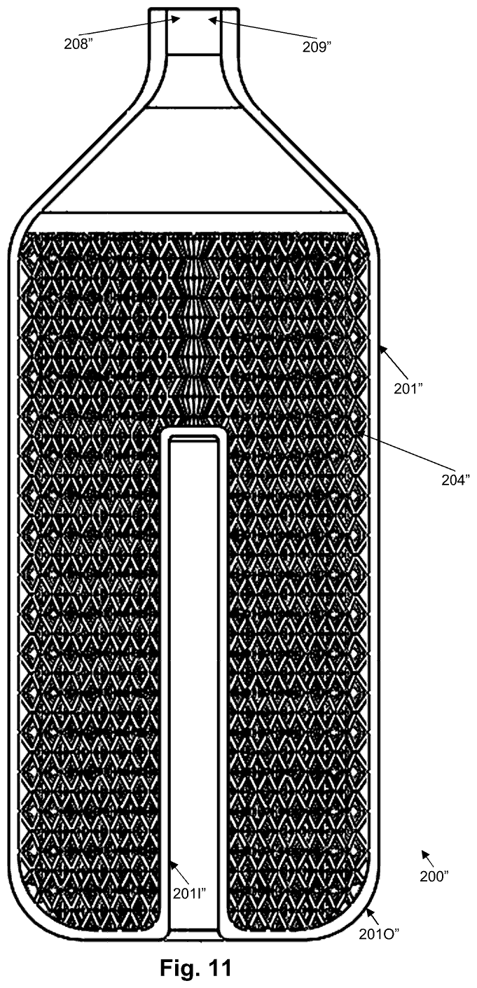

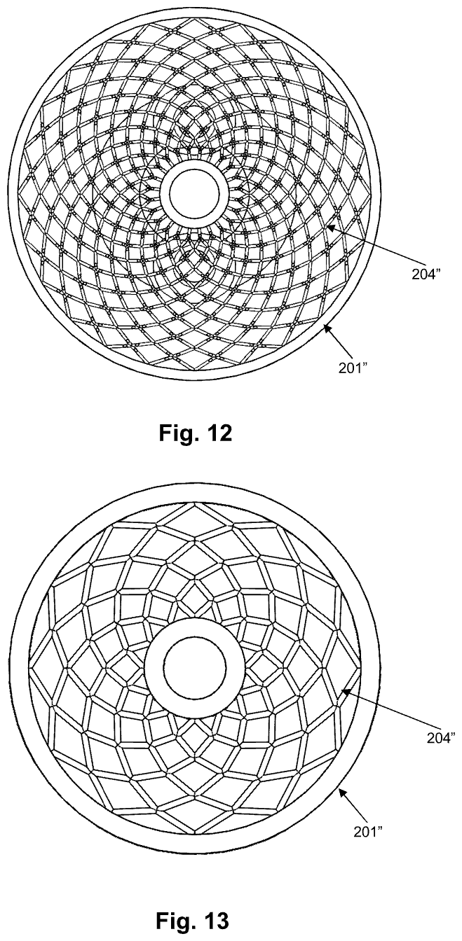

FIG. 10 is CAD cutaway perspective view of a hydrogen storage device 200″ for a power supply according to an exemplary embodiment. FIG. 11 is CAD axial cross-section of the hydrogen storage device 200″ of FIG. 10. FIG. 12 is a CAD radial cross-section of the hydrogen storage device 200″ of FIG. 10. The hydrogen storage device 200″comprises a pressure vessel 201″, having a first fluid inlet 208″ and a first fluid outlet 209″, comprising therein a thermally conducting network 204″ optionally thermally coupled to the first heater (not shown), wherein the pressure vessel 201″ is arranged to receive therein a hydrogen storage material (not shown) in thermal contact, at least in part, with the thermally conducting network 204″, wherein the first fluid inlet 208″ and/or the first fluid outlet 209″ are in fluid communication with the first releasable fluid inlet coupling (not shown) and/or the first releasable fluid outlet coupling (not shown), respectively; and preferably, wherein the thermally conducting network 204″ has a lattice geometry, a gyroidal geometry and/or a fractal geometry in two and/or three dimensions.

In this example, the pressure vessel 201″ is generally cylindrical, having a generally dished first end and a necked second end opposed thereto, and having a single aperture providing both the first fluid inlet 208″ and the first fluid outlet 209″. In other words, the pressure vessel 201″ is bottle-shaped. An inner wall portion 2011″ of the pressure vessel 201″ provides an axial cylindrical, elongate blind passageway 210″, arranged to receive a first heater 206″ (not shown), that extends from the first end towards the second end and that is coaxial with an outer wall portion 2010″ of the pressure vessel 201″. A second blind passageway in the first end is arranged to receive a thermocouple (not shown).

In this example, the thermally conducting network 204″ has a lattice geometry in three dimensions, in which generally each node is connected by four arms to four other nodes, respectively, in an axially adjacent preceding layer, such that generally each node is thus connected by eight arms to eight other nodes, four nodes in the axially adjacent preceding layer and four nodes in an axially adjacent proceeding layer. Nodes proximal the inner wall portion 2011″ and the outer wall portion 2010″ are similarly connected thereto, respectively. In one example, an effective density (also known as lattice volume ratio) of the lattice geometry is uniform in one, two or three dimensions (i.e. mutually orthogonal dimensions). In this example, an effective density of the lattice geometry is uniform in a first dimension, particularly axially, and non-uniform in mutually orthogonal second and third dimensions, particularly radially. Particularly, the effective density decreases radially outwards, such that there is faster heat transfer proximal the passageway 410 and hence the first heater. In this example, the thermally conducting network 404 is formed from an aluminium alloy. Alternatively, the thermally conducting network 404 may be formed from copper, respective alloys thereof such as brass or bronze alloys, and/or stainless steel, as described previously.

FIG. 13 is an alternative CAD radial cross-section for the hydrogen storage device 200″ of FIG. 10. In this example, a node density (i.e. number of nodes per unit volume) of the lattice geometry, generally otherwise similar to the lattice geometry of FIG. 12 mutatis mutandis, is relatively lower than that of the lattice geometry of FIG. 12. A cross-sectional area of the arms is relatively larger than that of FIG. 12.

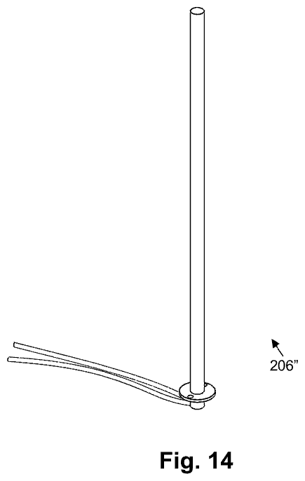

FIG. 14 is a CAD perspective view of a first heater 206″ for a hydrogen storage device for a power supply according to an exemplary embodiment. In this example, the first heater 206″ is an elongate cartridge heater, to be received in the passageway 210″. The first heater 206″ may be a push-fit into the passageway 210″, to improve thermal coupling between the first heater 206″ and the inner wall portion 2011″ of the pressure vessel 201″. Additionally and/or alternatively, the first heater 206″ may be thermally bonded to the inner wall portion 2011″, for example using conductive paste or solder.

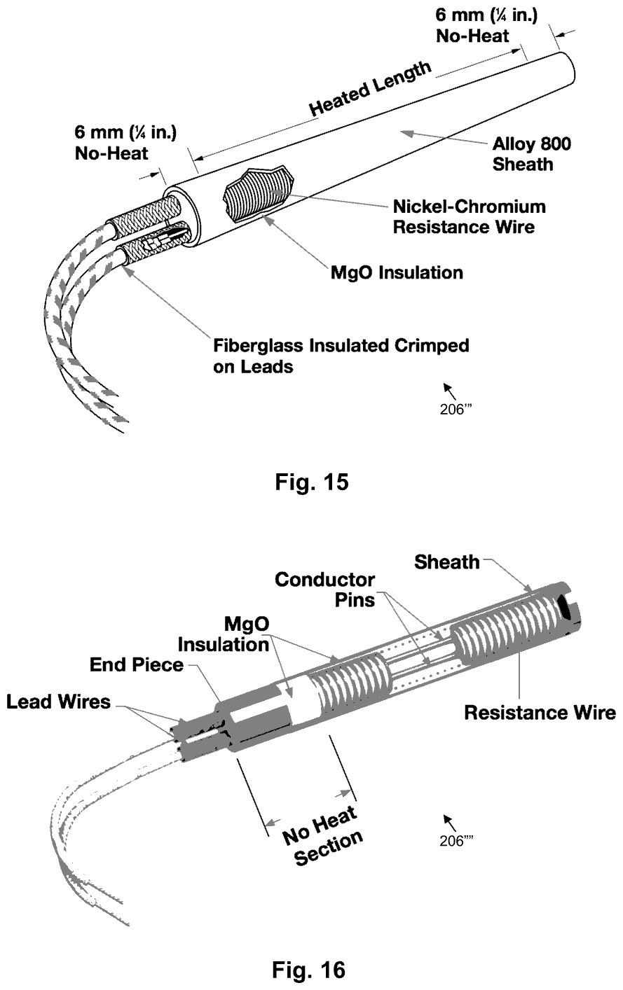

FIG. 15 is a cutaway perspective view of a first heater 206′″ for a hydrogen storage device for a power supply according to an exemplary embodiment, particularly a FIREROD cartridge heater available from Watlow.

FIG. 16 is a cutaway perspective view of a first heater 206′″ for a hydrogen storage device for a power supply according to an exemplary embodiment, particularly a FIREROD cartridge heater available from Watlow (part number G10A31, 10 inch length by ⅜ inch diameter 600 W (240V)). The first heater 506 is the metric equivalent of the first heater 206′″.

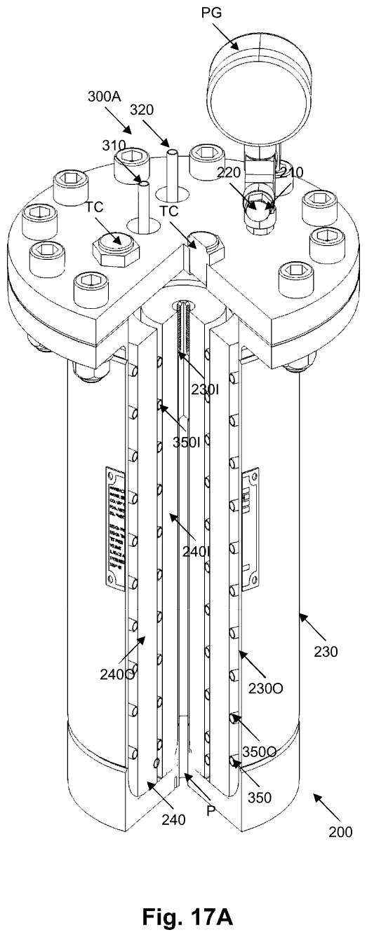

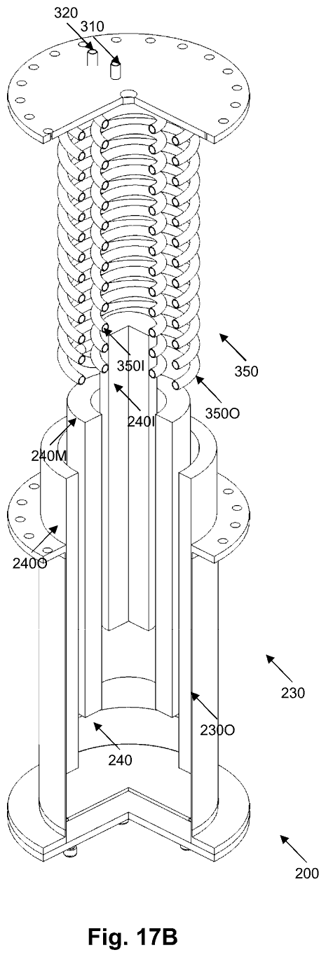

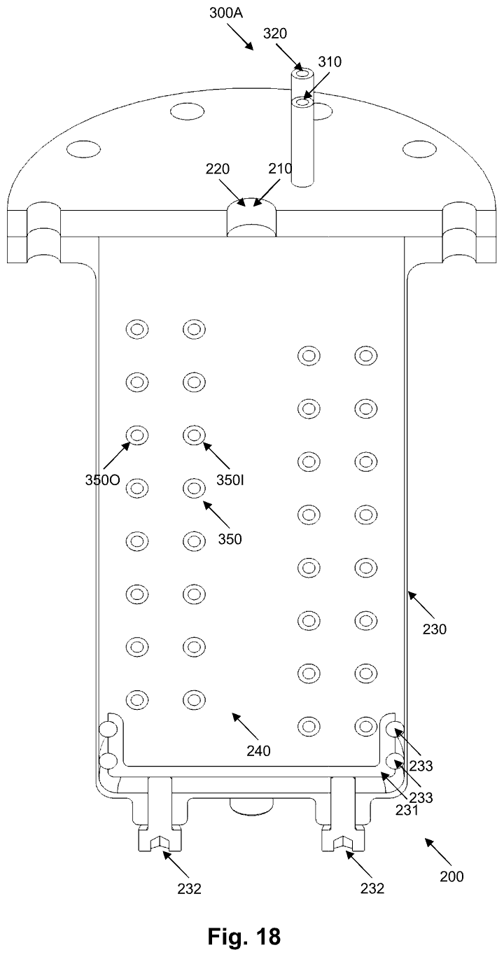

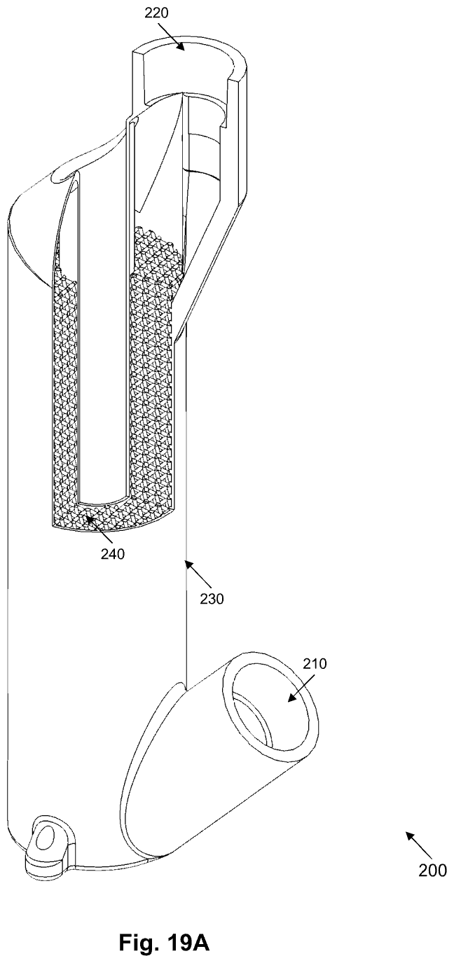

FIG. 17A is a cutaway perspective view of a hydrogen storage device 200 for a power supply according to an exemplary embodiment. The hydrogen storage device 200 comprises a pressure vessel 230, having a first fluid inlet 210 and a first fluid outlet 220, comprising therein a thermally conducting network 240 thermally coupled to a first heater 300A, wherein the pressure vessel 230 is arranged to receive therein a hydrogen storage material (not shown) in thermal contact, at least in part, with the thermally conducting network 240, wherein the first fluid inlet 210 and/or the first fluid outlet 220 are in fluid communication with the first releasable fluid inlet coupling (not shown) and/or the first releasable fluid outlet coupling (not shown), respectively; and wherein the thermally conducting network 240 has a lattice geometry in three dimensions.

In this example, the pressure vessel 230 is generally cylindrical, having a generally internally dished first end and a flanged second end opposed thereto, and having a single aperture providing both the first fluid inlet 210 and the first fluid outlet 220. In other words, the pressure vessel 230 is can-shaped. An inner wall portion 2301 of the pressure vessel 230 provides an axial cylindrical, elongate blind passageway P, arranged to optionally receive a second heater 300B (not shown) of the set of heaters 300, particularly a cartridge heater (not shown), that extends from the first end towards the second end and that is coaxial with an outer wall portion 2300 of the pressure vessel 230. Blind passageways in the second end are arranged to receive thermocouples TC. In this example, the first heater 300A is provided by a recirculating heater, for example heated using waste heat from a fuel cell coupled thereto, and includes a double helix heating tube 350, having an inlet 310 and an outlet 320, in thermal contact with the thermally conducting network 20, which is arranged between the inner 3501 and outer 3500 helices of the heating tube 350. The double helix heating tube 350 extends from the second end towards the first end is coaxial with an outer wall portion 2300 of the pressure vessel 230. The inner 3501 and outer 3500 helices of the double helix heating tube 350 are directly in thermal contact with the inner wall portion 2301 and the outer wall portion 2300 of the pressure vessel 230, respectively. A pressure gauge PG is provided in the second end. The second end is mechanically releasably coupled to the pressure vessel 230, using mechanical fasteners.

In this example, the thermally conducting network 240 has a lattice geometry in three dimensions, in which generally each node is connected by four arms to four other nodes, respectively, in an axially adjacent preceding layer, such that generally each node is thus connected by eight arms to eight other nodes, four nodes in the axially adjacent preceding layer and four nodes in an axially adjacent proceeding layer. Nodes proximal the inner 3501 and outer 3500 helices of the heating tube 350 are in mutual thermal contact therewith. In this example, an effective density of the lattice geometry is uniform in a first dimension, particularly axially, and non-uniform in mutually orthogonal second and third dimensions, particularly radially. In this example, the thermally conducting network 240 has a porosity of at least 90%. In this example, the thermally conducting network 240 is formed from an aluminium alloy. In this example, the thermally conducting network 240 comprises inner 2401 and outer 2400 portions, having annular shapes. The outer portion 2400 is received in thermal contact with and between the inner 3501 and outer 3500 helices of the double helix heating tube 350 while the inner portion 2401 is received in thermal contact with and within the inner helix 3501.

FIG. 17B is a cutaway perspective exploded view of a related hydrogen storage device 200. In contrast with the hydrogen storage device 200 of FIG. 17A, the thermally conducting network 240 of the hydrogen storage device 200 of FIG. 17B comprises inner 2401, middle 240M and outer 2400 portions. The inner portion 2401 has a cylindrical shape and the middle 240M and outer 2400 portions have annular shapes. The outer portion 2400 is received in thermal contact and without the outer 3500 helices of the double helix heating tube 350, the middle portion 240M is received in thermal contact with and between the inner 3501 and outer 3500 helices while the inner portion 2401 is received in thermal contact with and within the inner helix 3501.

FIG. 14 is a cutaway perspective view of a hydrogen storage device for a power supply according to an exemplary embodiment. The hydrogen storage device 200 is generally as described with respect to the hydrogen storage devices 200 of FIGS. 17A and 17B and like reference signs denote like features.

In contrast with the hydrogen storage device 200 of FIGS. 17A and 17B, the hydrogen storage device 200 does not include the inner wall portion 2301 of the pressure vessel 230 of FIGS. 17A and 17B and does not include blind passageways in the second end to receive thermocouples. In contrast with the hydrogen storage device 200 of FIGS. 17A and 17B, the thermally conducting network 240 is cylindrical, to be received in thermal contact with the outer wall portion 2300 of the pressure vessel 230. In contrast with the hydrogen storage device 200 of FIGS. 17A and 17B, the inner 3501 and outer 3500 helices of the double helix heating tube 350 are integrated within the thermally conducting network 240. Hence, the inner 3501 and outer 3500 helices of the double helix heating tube 350 are mutually spaced apart from and only indirectly in thermal contact with the outer wall portion 2300 of the pressure vessel 230, respectively, via the thermally conducting network 240. In this example, the hydrogen storage device 200 includes a bed compression disc 231, internal to the pressure vessel 230 proximal the first end and bed compression disc bolts 232 mechanically coupled thereto, extending through the first end, for uniaxially compressing the hydrogen storage material to improve thermal contact with the thermally conducting network. O-rings 233 are arranged in the outer wall portion 2300 to prevent loss of the hydrogen storage material during compression thereof.

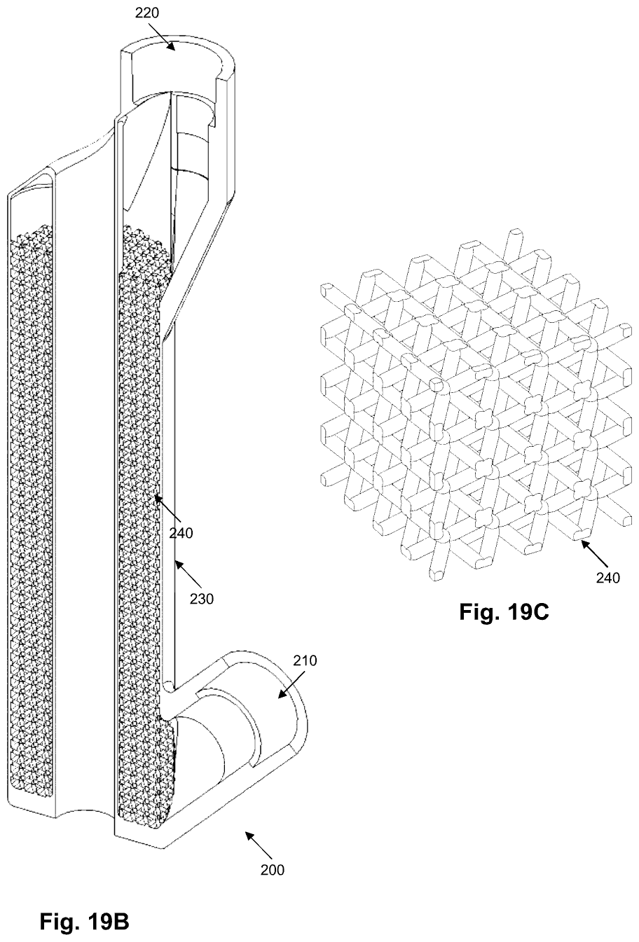

FIG. 19A is a CAD partial cutaway perspective view of a hydrogen storage device 200 for a power supply according to an exemplary embodiment; FIG. 19B is a CAD longitudinal perspective cross-sectional view of the hydrogen storage device 200; and FIG. 19C is a CAD perspective view of the thermally conducting network, in more detail.

The hydrogen storage device 200 comprises a pressure vessel 230, having a first fluid inlet 210 and a first fluid outlet 220, comprising therein a thermally conducting network 240 thermally coupled to a first heater 300A, wherein the pressure vessel 230 is arranged to receive therein a hydrogen storage material (not shown) in thermal contact, at least in part, with the thermally conducting network 240, wherein the first fluid inlet 210 and/or the first fluid outlet 220 are in fluid communication with the first releasable fluid inlet coupling (not shown) and/or the first releasable fluid outlet coupling (not shown), respectively; and wherein the thermally conducting network 240 has a lattice geometry in three dimensions. In this example, the hydrogen storage material comprises and/or is a liquid organic hydrogen carrier, LOHC. In this example, the hydrogen storage device 200 is a dynamic hydrogen storage device 200. In this example, the first fluid inlet 210 and the first fluid outlet 220 are mutually spaced apart at opposed ends of the first vessel 230, thereby defining, at least in part, a path for flow of the hydrogen storage material and/or hydrogen therebetween, for example via the voids of the thermally conducting network 240. In this example, the first fluid inlet 210 and the first fluid outlet 220 comprise releasable couplings, thereby providing coupling thereto and uncoupling therefrom, for example repeatedly, of corresponding couplings. In this example, the lattice geometry is Bravais lattice particularly a cubic lattice specifically a primitive cubic lattice. In this example, the thermally conducting arms have a cross sectional dimension (for example a diameter or a width) of about 0.5 mm. In this example, the thermally conducting network 240 partially fills an internal volume of the first vessel 230, of at least 90%, by volume of the first vessel 230. In this example, the thermally conducting network 240 comprises a LOHC hydrogenation and/or dehydrogenation catalyst, for example provided on and/or in a surface thereof. In this example, the thermally conducting network 240 has a porosity in a range from 75% to 95%, by volume of the thermally conducting network 240. In this example, the thermally conducting network 240 has a specific surface area in a range from 1 m⁻¹ to 10 m⁻¹, particularly about 7 m⁻¹. In this example, the thermally conducting network 240 comprises a LOHC hydrogenation and/or dehydrogenation catalyst, for example provided on and/or in a surface thereof. In this example, the first heater is arranged heat the hydrogen storage material to temperature in a range from 150° C. to 300° C. In this example, the hydrogen storage device 200 comprises a pump (not shown) arranged to flow the hydrogen storage material through the first vessel 230. In this example, the hydrogen storage device 200 is a reactor.

Generally, the first vessel 230 is an elongated cylinder formed from a Ti alloy (to withstand an operating pressure of about 2 bar at a temperature of about 260° C. for dehydrogenation), having a bore extending therethrough for the first heater, particularly a Joule cartridge heater. The first fluid inlet 210 and the first fluid outlet 220 are provided with Swagelok releasable couplings. The first fluid inlet 210 is arranged at an acute angle to the axis of the first vessel and the first fluid outlet is arranged parallel to the axis, to suit the particular application.

### SUMMARY

A power supply and a method of controlling such a power supply are provided. The power supply has a first electrical outlet, and comprises a set of hydrogen storage devices, including a first hydrogen storage device, optionally a set of heaters including a first heater, a first releasable fluid inlet coupling and/or a first releasable fluid outlet coupling; wherein the first hydrogen storage device comprises: a pressure vessel, having a first fluid inlet and a first fluid outlet, comprising therein a thermally conducting network optionally thermally coupled to the first heater, wherein the pressure vessel is arranged to receive therein a hydrogen storage material in thermal contact, at least in part, with the thermally conducting network, wherein the first fluid inlet and/or the first fluid outlet are in fluid communication with the first releasable fluid inlet coupling and/or the first releasable fluid outlet coupling, respectively; and preferably, wherein the thermally conducting network has a lattice geometry, a gyroidal geometry and/or a fractal geometry in two and/or three dimensions. In this way, the power supply provides a modular and/or scalable source of electrical power, obtainable from hydrogen stored in the hydrogen storage material. Particularly, the hydrogen stored in the hydrogen storage material may be released, for example by heating thereof, via the thermally conducting network, by the first heater. Chemical energy of the released hydrogen may be then converted, at least in part, to electrical energy via an electrical generator. Furthermore, modularity and/or scalability of the power supply is provided by the first releasable fluid inlet coupling and/or the first releasable fluid outlet coupling. For example, by coupling and subsequently recoupling the first releasable fluid inlet coupling, different hydrogen gas generators, having different capacities, availabilities and/or characteristics, may be coupled to the set of hydrogen storage devices. For example, by coupling and subsequently recoupling the first releasable fluid outlet coupling, different electrical generators, such as fuel cells and/or conventional combustion electrical generators, having different capacities, efficiencies, availabilities and/or characteristics, may be coupled to the set of hydrogen storage devices. In this way, the power supply may be configured efficiently for a particular electrical power output, for example a peak electrical output, a total capacity and/or a duration of the power supply, as required for expected usage and/or demand.

### Definitions

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processor circuits. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” may mean including the component(s) specified but is not intended to exclude the presence of other components.

Although a few example embodiments have been shown and described, it will be appreciated by those skilled in the art that various changes and modifications might be made without departing from the scope of the invention, as defined in the appended claims.

1. A power supply, having a first electrical outlet, comprising:
a set of hydrogen storage devices, including a first hydrogen storage device, a set of heaters including a first heater, and either or both of a first releasable fluid inlet coupling and a first releasable fluid outlet coupling;
wherein the first hydrogen storage device comprises:
a pressure vessel, having a first fluid inlet and a first fluid outlet, comprising therein a thermally conducting network thermally coupled to the first heater, wherein the pressure vessel is arranged to receive therein a hydrogen storage material in thermal contact, at least in part, with the thermally conducting network, wherein either or both of the first fluid inlet and the first fluid outlet are in fluid communication with either or both of the first releasable fluid inlet coupling and the first releasable fluid outlet coupling, respectively; and
wherein the thermally conducting network has one or more of a lattice geometry, a gyroidal geometry, or a fractal geometry in either or both of two dimensions and three dimensions.

2. The power supply according to claim 1, further comprising:
a set of electrical generators, including a first electrical generator, configured to generate electricity using hydrogen gas, selected from a group comprising a fuel cell and an electrical generator comprising a heat engine, a second releasable fluid inlet coupling coupleable to the first releasable fluid outlet coupling, and/or a first releasable electrical outlet coupling coupleable to the first electrical outlet;
wherein the first electrical generator comprises a second fluid inlet in fluid communication with the second releasable fluid inlet coupling.

3. The power supply according to claim 2, wherein the first electrical generator is the fuel cell, selected from a group comprising a proton exchange membrane fuel cell, PEMFC, an alkaline fuel cell, AFC, and a phosphoric acid fuel cell, PAFC.

4. The power supply according to claim 1, further comprising:
a set of hydrogen gas generators, including a first hydrogen gas generator configured to generate hydrogen gas, a third releasable fluid inlet coupling and/or a second releasable fluid outlet coupling coupleable to the first releasable fluid inlet coupling.

5. The power supply according to claim 4, wherein the first hydrogen gas generator comprises an electrolysis cell selected from a group comprising an alkaline electrolysis cell and a proton exchange membrane, PEM, electrolysis cell.

6. The power supply according to claim 3 any of claims 3 to 5, having a first electrical inlet coupleable to the first hydrogen gas generator and/or wherein the first electrical outlet is coupleable to the first hydrogen gas generator.

7. The power supply according to claim 1, arrangeable in:
a first arrangement, wherein the first hydrogen gas generator, the first hydrogen storage device and the first electrical generator are mutually uncoupled; and
a second arrangement, wherein the first hydrogen gas generator and the first electrical generator are fluidically coupled via the first hydrogen storage device.

8. The power supply according to claim 1, further comprising:
a housing comprising a set of walls, including a first wall, arranged to house the set of hydrogen storage devices and having the first electrical outlet through the first wall.

9. The power supply according to claim 1, further comprising:
a controller configured to control the first heater based, at least in part, on a rate of electrical energy output via the first electrical outlet.

10. The power supply according to claim 1, wherein:
the controller is configured to control the first heater based, at least in part, on a predicted rate of electrical energy output via the first electrical outlet.

11. The power supply according to claim 1, wherein the first hydrogen storage device comprises the hydrogen storage material and wherein the hydrogen storage material comprises and/or is a solid hydride and/or a liquid organic hydrogen carrier, LOHC.

12. A method of controlling a power supply comprising a set of hydrogen gas generators, including a first hydrogen gas generator, a set of hydrogen storage devices, including a first hydrogen storage device, a set of heaters including a first heater, a set of electrical generators, including a first electrical generator and a controller;
wherein the first hydrogen storage device comprises:
a pressure vessel, having a first fluid inlet and a first fluid outlet, comprising therein a thermally conducting network thermally coupled to the first heater, wherein the pressure vessel is arranged to receive therein a hydrogen storage material in thermal contact, at least in part, with the thermally conducting network, and wherein the thermally conducting network has either or both of a lattice geometry and a fractal geometry in either or both of two dimensions and three dimensions;
wherein the method comprises:
generating, by the first hydrogen gas generator, hydrogen gas;
storing, by the first hydrogen storage device, the generated hydrogen gas;
releasing, at least in part, the stored hydrogen gas comprising controlling, by the controller, the first heater to release, at least in part, the stored hydrogen gas; and
generating, by the first electrical generator, electrical energy using the released hydrogen gas.

13. The method according to claim 12, wherein the method further comprises:
controlling, by the controller, the first heater based, at least in part, on a rate of electrical energy generation by the first electrical generator.

14. The method according to claim 12, wherein the method further comprises:
controlling, by the controller, the first heater based, at least in part, on a predicted rate of electrical energy generation by the first electrical generator.

15. The method according to claim 12, wherein the method further comprises:
controlling, by the controller, a rate of hydrogen gas generated by the first hydrogen gas generator based, at least in part, on a rate of electrical energy generation by the first electrical generator.

16. A tangible non-transient computer-readable storage medium having recorded thereon instructions which when implemented by a computer device comprising a processor and a memory, cause the computer device to perform a method according to claim 12.
